(19) United States
(12) Patent Application Publication
(10) Pub. No.: US 2026/0202952 A1
(43) Pub. Date: Jul. 16, 2026

(54) ELECTRONIC DEVICE FOR DISPLAYING EXECUTION SCREEN OF APPLICATION BASED ON USER INPUT, AND OPERATION METHOD THEREFOR

(71) Applicant: Samsung Electronics Co., Ltd., Suwon-si (KR)

(72) Inventors: Haeree NA, Suwon-si (KR); Heekyung MOON, Suwon-si (KR); Wanje PARK, Suwon-si (KR); Jinwan AN, Suwon-si (KR); Junhee CHO, Suwon-si (KR)

(21) Appl. No.: 19/562,283

(22) Filed: Mar. 10, 2026

Related U.S. Application Data
(63) Continuation of application No. PCT/KR2024/013620, filed on Sep. 9, 2024.

(30) Foreign Application Priority Data
Sep. 11, 2023 (KR) 10-2023-0120253
Nov. 6, 2023 (KR) 10-2023-0151851

(51) Int. Cl. G06F 3/04845; G06F 3/0481

(52) U.S. Cl. CPC G06F 3/04845; G06F 3/0481; G06F 2203/04803; G06F 2203/04804

(57) ABSTRACT

An electronic device includes a processor and a display. The processor is configured to: display a user interface, including a first object indicating a first application, in a first area among display areas of the display; identify a first user input for selecting the first object; identify a second user input for selecting a position in which to display a first window, including a first execution screen of the first application, in a second area among the display areas in a state in which the first user input is maintained; identify at least one attribute of the first execution screen on the basis of identifying a third user input directly following the second user input; and based on confirming the release of the third user input, display, in the second area, the first window including the first execution screen corresponding to the at least one attribute.

### CROSS-REFERENCE TO RELATED APPLICATIONS

This application is a continuation of International Application No. PCT/KR2024/013620 designating the United States, filed on Sep. 9, 2024, in the Korean Ministry of Intellectual Property Receiving Office and claiming priority to Korean Patent Application Nos. 10-2023-0120253, filed on Sep. 11, 2023, and 10-2023-0151851, filed on Nov. 6, 2023, in the Korean Ministry of Intellectual Property, the disclosures of each of which are incorporated by reference herein in their entireties.

### BACKGROUND

### Field

The disclosure relates to an electronic device displaying an execution screen of an application based on a user input, and an operating method thereof.

### Description of Related Art

Recently, with the rapid increase in demand for smartphones and tablets, research on user interface methods related to touchscreens provided in these devices may be actively conducted. Research is being conducted specifically to enable smartphones or tablets to offer nearly intuitive interface methods related to user experience. Consequently, interface methods that align with user intuition in various ways are being disclosed.

Most smartphones and tablets are equipped with touchscreens, and consequently, recent research on interface methods aims to develop a way for users to manipulate these touchscreens more easily and accurately.

### SUMMARY

According to an example embodiment, an electronic device may include at least one processor, comprising processing circuitry, a display, and memory storing instructions.

According to an example embodiment, at least one processor, individually and/or collectively, may be configured to execute the instructions and to cause the electronic device to display a user interface including a first object representing a first application on a first area among display areas of the display.

According to an example embodiment, the electronic device may identify a first user input to select the first object.

According to an example embodiment, the electronic device may identify a second user input to select a position to display a first window including a first execution screen of the first application on a second area of the display areas while the first user input is maintained.

According to an example embodiment, the electronic device may identify at least one attribute of the first execution screen based on identifying a third user input that is consecutive to the second user input.

According to an example embodiment, the electronic device may display the first window including the first execution screen corresponding to the at least one attribute on the second area based on identifying that the third user input is released.

According to an example embodiment, the electronic device may display the first window including the first execution screen corresponding to the at least one attribute on the second area based on identifying that the first user input and the third user input are released.

According to an example embodiment, a method of operating the electronic device may include displaying a user interface including a first object representing a first application on a first area among display areas of the display.

According to an example embodiment, the method of operating the electronic device may include identifying a first user input to select the first object.

According to an example embodiment, the method of operating the electronic device may include identifying a second user input to select a position to display a first window including a first execution screen of the first application on a second area of the display areas while the first user input is maintained.

According to an example embodiment, the method of operating the electronic device may include determining at least one attribute of the first execution screen based on identifying a third user input that is consecutive to the second user input.

According to an example embodiment, the method of operating the electronic device may include displaying the first window including the first execution screen corresponding to the at least one attribute on the second area based on identifying that the third user input is released.

According to an example embodiment, in a non-transitory computer-readable storage medium storing computer-readable instructions, the instructions, when executed by at least one processor, comprising processing circuitry, of an electronic device, individually and/or collectively, cause the electronic device to perform at least one operation, comprising controlling the display to display a user interface including a first object representing a first application on a first area among display areas of a display included in the electronic device.

According to an example embodiment, in a non-transitory computer-readable storage medium storing computer-readable instructions, the instructions, when executed by a processor of an electronic device, cause the electronic device to perform at least one operation, comprising identifying a first user input to select the first object.

According to an example embodiment, in a non-transitory computer-readable storage medium storing computer-readable instructions, the instructions, when executed by a processor of an electronic device, cause the electronic device to perform at least one operation, comprising identifying a second user input to select a position to display a first window including a first execution screen of the first application on a second area of the display areas while the first user input is maintained.

According to an example embodiment, in a non-transitory computer-readable storage medium storing computer-readable instructions, the instructions, when executed by a processor of an electronic device, cause the electronic device to perform at least one operation, comprising identifying at least one attribute of the first execution screen based on identifying a third user input that is consecutive to the second user input.

According to an example embodiment, in a non-transitory computer-readable storage medium storing computer-readable instructions, the instructions, when executed by a processor of an electronic device, cause the electronic device to perform at least one operation, comprising displaying the first window including the first execution screen corresponding to the at least one attribute on the second area based on identifying that the third user input is released.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example electronic device in a network environment according to one or more embodiments.

FIGS. 2A and 2B are diagrams illustrating an example operation of an electronic device determining an attribute of an execution screen of an application based on a user input according to one or more embodiments.

FIG. 3 is a block diagram illustrating an example configuration of an electronic device according to one or more embodiments.

FIG. 4 is a flowchart illustrating an example operation of an electronic device displaying a first window based on at least one determined attribute according to one or more embodiments.

FIG. 5 is a flowchart illustrating an example operation of an electronic device displaying a second window based on at least one determined attribute according to one or more embodiments.

FIG. 6 is a flowchart illustrating an example operation of an electronic device adjusting a display position of at least one of a first window or a second window according to one or more embodiments.

FIG. 7 is a flowchart illustrating an example operation of an electronic device dividing and displaying a portion of a first execution screen and a portion of a second execution screen in one window according to one or more embodiments.

FIG. 8 is a flowchart illustrating an example operation of an electronic device determining an attribute of a first execution screen corresponding to a third area where a third user input is identified according to one or more embodiments.

FIG. 9 is a flowchart illustrating an example operation of an electronic device determining a size of a window according to one or more embodiments.

FIG. 10 is a flowchart illustrating an example operation of an electronic device determining a display position of a second window based on a speed and a direction of a user input according to one or more embodiments.

FIG. 11 is a flowchart illustrating an example operation of an electronic device displaying a first window based on at least one determined attribute according to one or more embodiments.

FIG. 12A is a diagram illustrating an example operation of an electronic device identifying a user input to select a position to display a first execution screen according to one or more embodiments.

FIGS. 12B, 12C, and 12D are diagrams illustrating an example operation of an electronic device displaying a first window according to one or more embodiments.

FIGS. 13A, 13B and 13C are diagrams illustrating an example operation of an electronic device displaying a guide representing at least one position where a first execution screen may be displayed according to one or more embodiments.

FIGS. 14A and 14B are diagrams illustrating an example operation of an electronic device adjusting display positions of a plurality of windows according to one or more embodiments.

FIGS. 15A and 15B are diagrams illustrating an example operation of an electronic device dividing and displaying a plurality of execution screens in one window according to one or more embodiments.

FIGS. 16A and 16B are diagrams illustrating an example operation of an electronic device displaying a window according to one or more embodiments.

FIGS. 17A and 17B are diagrams illustrating an example operation of an electronic device determining a size of a window according to one or more embodiments.

FIG. 18 is a diagram illustrating an example operation of an electronic device determining an attribute of an execution screen based on an area where a user input is identified according to one or more embodiments.

FIG. 19 is a diagram illustrating an example operation of an electronic device determining a position where a window is displayed based on a direction and a speed of a user input according to one or more embodiments.

FIGS. 20A and 20B are diagrams illustrating an example operation of an electronic device displaying a plurality of windows according to one or more embodiments.

FIG. 21A is a diagram illustrating an example operation of an electronic device displaying at least one area where an execution screen of an application may be displayed according to one or more embodiments.

FIG. 21B is a diagram illustrating an example operation of an electronic device determining an attribute of an execution screen of an application according to one or more embodiments.

FIGS. 22A and 22B are diagrams is a illustrating an example operation of an electronic device displaying an object representing an application according to one or more embodiments.

### DETAILED DESCRIPTION

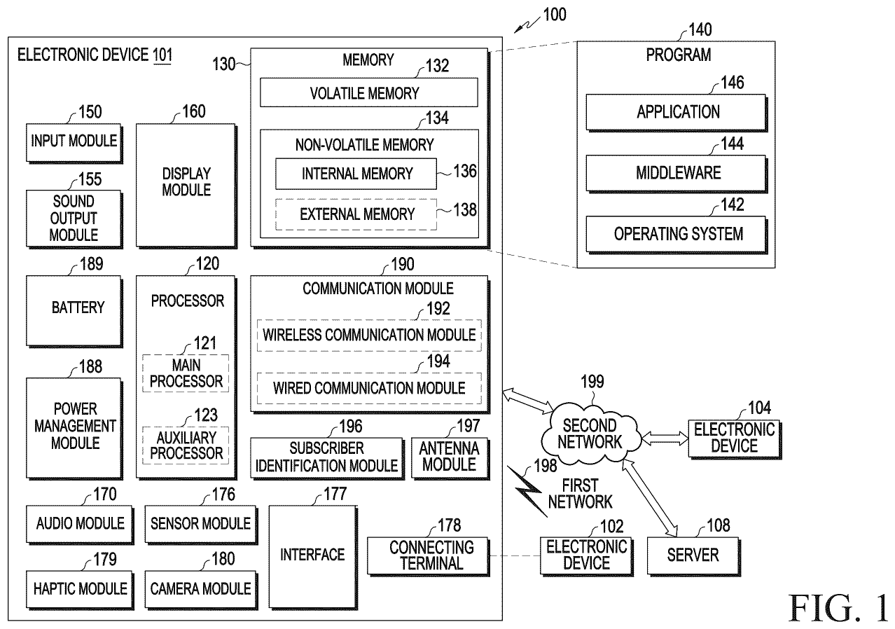

FIG. 1 is a block diagram illustrating an example electronic device 101 in a network environment 100, according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

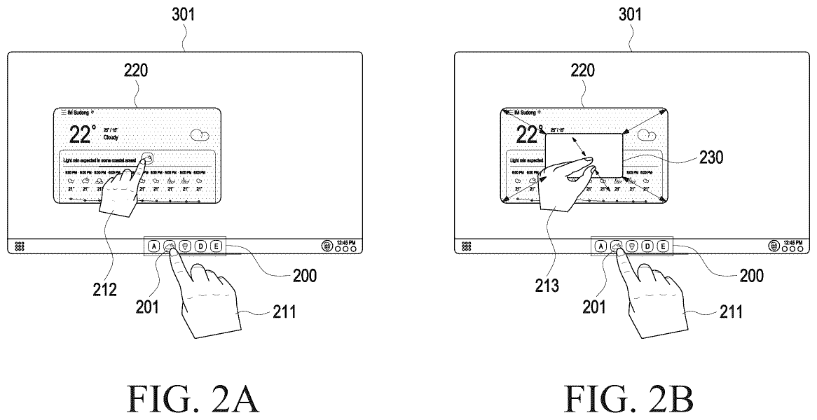

FIGS. 2A and 2B are diagrams illustrating an example operation of an electronic device determining an attribute of an execution screen of an application based on a user input according to one or more embodiments.

According to an embodiment, an electronic device 301 may determine a position where a window including an execution screen of an application is to be displayed among display areas of a display 360 and at least one attribute of the execution screen of the application based on at least one input of a user. For example, the at least one attribute may include a size, a color, a brightness, or a transparency of the execution screen. According to an embodiment, when at least one input of the user is released, the electronic device 301 may display the window including the execution screen of the application based on the position and/or the at least one attribute determined according to the at least one input. For example, the electronic device 301 may display the window (or the execution screen of the application) reflecting the at least one attribute (size, brightness, and/or transparency) determined according to the at least one user input at the position determined according to the at least one user input.

Referring to FIG. 2A, according to an embodiment, the electronic device 301 may display a user interface 200 including at least one object representing at least one application. For example, the at least one object may represent an object (e.g., an icon and/or content) for executing the corresponding application. According to an embodiment, the electronic device 301 may identify a first user input 211 on a first object 201 representing a first application included in the user interface 200. For example, the first user input 211 may include a long press input. For example, the first user input 211 may include a touch input, a touch hovering input, or a gesture input (e.g., a gesture input for a video see through (VST) device).

According to an embodiment, the electronic device 301 may identify a second user input 212 to select a position to display a first window including an execution screen of the first application while the first user input 211 is maintained (or not released). According to an embodiment, the electronic device 301 may display a designated screen 220 representing the first application at a position where the second user input 212 is identified based on identifying the second user input 212. For example, the second user input 212 may include a long press input. For example, the second user input 212 may include a touch input, a touch hovering input, or a gesture input (e.g., a gesture input for a VST device).

Referring to FIG. 2B, according to an embodiment, the electronic device 301 may identify a third user input 213 that is consecutive to the second user input 212 while the second user input 212 is not released (or maintained). For example, the third user input 213 may include a swipe input, a touch and drag input, a pinch input, a pinch in input, or a pinch out input. For example, the third user input 213 may include a touch input, a touch hovering input, or a gesture input (e.g., a gesture input for a VST device).

According to an embodiment, when a new user input is identified within a designated time after movement of the second user input 212 is stopped, the electronic device 301 may identify or determine the new user input as the third user input 213. In this case, the electronic device 301 may identify or determine that the third user input 213 is consecutive to the second user input 212. For example, the designated time may be automatically set by the electronic device 301 or set by the user.

According to an embodiment, when a new user input is identified after the designated time has exceeded from when the movement of the second user input 212 is stopped, the electronic device 301 may not identify the new user input as the third user input 213. In this case, the electronic device 301 may identify or determine the new user input as a separate user input different from the third user input 213.

According to an embodiment, the electronic device 301 may determine the size of the first execution screen of the first application based on the third user input 213. For example, the first execution screen may represent the execution screen of the first application. According to an embodiment, the electronic device 301 may display a screen 230 representing the first execution screen having the determined size on the designated screen 220 representing the first application.

According to an embodiment, the electronic device 301 may execute the first application based on the third user input 213 being released. According to an embodiment, the electronic device 301 may display the first window including the first execution screen having the determined size based on the third user input 213 being released. According to an embodiment, the electronic device 301 may display the first window including the first execution screen having the determined size based on the first user input 211 and the third user input 213 being released. However, the method of displaying the first window may not be limited thereto and may be varied or modified within a range understood by those skilled in the art. For example, the electronic device 301 may display the first window based on release of an additional user input in addition to the first user input 211 and the third user input 213. The electronic device 301 may display the first window when it is identified that the first user input is released.

According to an embodiment, the user may select a position where a window including an execution screen of an application is to be displayed using one hand, and determine at least one attribute of the execution screen of the application based on a consecutive user input using the other hand. The electronic device 301 may provide a convenient environment to the user by displaying the window including the execution screen of the application having the attribute determined according to the user's input.

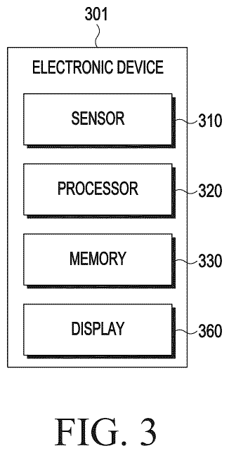

FIG. 3 is a block diagram illustrating an example configuration of an electronic device according to one or more embodiments.

Referring to FIG. 3, according to an embodiment, an electronic device 301 may include a sensor 310, a processor (e.g., including processing circuitry) 320, memory 330, and a display 360.

According to an embodiment, the electronic device 301 may be implemented as a video see through (VST) device, a smartphone, or a tablet personal computer (PC). However, this is an example, and the electronic device 301 may be implemented as various devices.

According to an embodiment, the sensor 310 may be implemented as a touch sensor sensing an input of the user. According to an embodiment, the sensor 310 may be implemented identically or similarly to the sensor module 176 of FIG. 1.

According to an embodiment, the processor 320 may include various processing circuitry and control the overall operation of the electronic device 301. According to an embodiment, the processor 320 may be implemented identically or similarly to the processor 120 of FIG. 1 and the description of the processor 120 above applies equally to the processor 320 here. Therefore, a redundant description may not be repeated here.

An operation of the processor 320 identifying a user input may include an operation of identifying the user input or an operation of determining the user input. According to an embodiment, the user input may be performed by a body portion (e.g., a hand) of the user or by a stylus pen.

According to an embodiment, the processor 320 may display a user interface on a first area among display areas of the display 360. According to an embodiment, the user interface may include at least one object representing at least one application. For example, the at least one object representing the at least one application may represent an object (e.g., an icon and/or content) for executing the at least one application.

According to an embodiment, the processor 320 may identify a first user input to select a first object representing a first application included in the user interface through the sensor 310. According to an embodiment, the first user input may include a touch input, a touch gesture, a long press input, or a long press gesture.

According to an embodiment, the processor 320 may display a guide representing at least one area where the first execution screen may be displayed among the display areas of the display 360 based on identifying the first user input. According to an embodiment, areas where execution screens of a plurality of applications may be displayed may be different for each of the plurality of applications. According to an embodiment, the processor 320 may display a guide representing at least one area where the first object may be displayed among the display areas of the display 360 based on identifying the first user input.

According to an embodiment, the processor 320 may identify a second user input to select a position to display a first window including a first execution screen of the first application on a second area of the display areas of the display 360 through the sensor 310 while the first user input is maintained. According to an embodiment, the second user input may include a touch input, a touch gesture, a long press input, or a long press gesture.

According to an embodiment, the processor 320 may display a designated screen representing the first application on the second area where the second user input is identified based on identifying the second user input. According to an embodiment, the designated screen representing the first application may include a screen including the first object or a screen designated by the user. According to an embodiment, the electronic device 301 may apply a visual effect to the designated screen representing the first application and display it on the second area where the second user input is identified. For example, the visual effect may include an effect of adjusting a color or a transparency of the designated screen.

According to an embodiment, the processor 320 may identify a third user input that is consecutive to the second user input on the second area through the sensor 310 while the second user input is not released. According to an embodiment, the processor 320 may identify the third user input as an input consecutive to the second user input when the third user input is identified within a preset (e.g., specified) time from when the second user input is identified. For example, the preset time may represent a time during which the third user input is identified as the input consecutive to the second user input. The preset time may be automatically set by the processor 320 or set by the user. According to an embodiment, the third user input may include a swipe, a drag, a pinch, a pinch in, or a pinch out input (or gesture).

According to an embodiment, the processor 320 may determine at least one attribute of the first execution screen based on the third user input. According to an embodiment, the at least one attribute may include at least one of a size, a transparency, a color, a depth, or a brightness of the first execution screen.

According to an embodiment, the processor 320 may determine an attribute corresponding to an area where the third user input is identified among the at least one attribute. For example, when the third user input is identified on the second area, the processor 320 may determine an attribute corresponding to the second area among the at least one attribute. For example, the attribute corresponding to the second area may include a first attribute (e.g., size). For example, when the third user input is identified on a third area different from the second area, the processor 320 may determine an attribute corresponding to the third area among the at least one attribute. For example, the attribute corresponding to the third area may include a second attribute (e.g., transparency) different from the first attribute. According to an embodiment, a plurality of areas may be set to adjust the attribute of the first execution screen. However, the corresponding content overlaps with the above-described content and may not be repeated here.

According to an embodiment, the processor 320 may identify a distance (e.g., a moving direction and a moving distance of the third user input) between positions where the third user input is identified through the sensor 310. According to an embodiment, the processor 320 may identify a first distance between a first position and a second position where the third user input representing a pinch, a pinch in, or a pinch out is identified. According to an embodiment, the processor 320 may identify a first distance between a first position and a second position where the third user input representing a swipe input or a drag input is identified. For example, the first position where the third user input representing the swipe input or the drag input is identified may represent a start point of the third user input, and the second position where the third user input representing the swipe input or the drag input is identified may represent an end point of the third user input.

According to an embodiment, the processor 320 may determine the at least one attribute corresponding to the direction of the third user input or the first distance. According to an embodiment, the attribute corresponding to the direction of the third user input or the distance between the positions where the third user input is identified may be set by the user or automatically set by the processor 320.

For example, when the third user input is identified as an input swiping or dragging from bottom to top, the processor 320 may determine that the larger the first distance, the larger the size, the transparency, or the brightness of the first execution screen. For example, when the third user input is identified as an input swiping or dragging from top to bottom, the processor 320 may determine that the larger the first distance, the larger the size, the transparency, or the brightness of the first execution screen. For example, when the third user input is identified as a pinch in or a pinch out input, the processor 320 may determine that the larger the first distance, the larger the size, the transparency, or the brightness of the first execution screen.

According to an embodiment, the processor 320 may identify whether the third user input is released. According to an embodiment, the processor 320 may execute the first application based on the third user input being released. Further, the processor 320 may execute the first application to display the first execution screen (or the first window including the first execution screen). According to an embodiment, when it is identified that the third user input is not released, the processor 320 may not execute the first application. In this case, the processor 320 may not display the first execution screen. However, the processor 320 may display a guide (e.g., a designated screen related to the first application) for determining the attribute of the first application without executing the first application.

According to an embodiment, the processor 320 may display the first window including the first execution screen on the second area based on the determined at least one attribute.

According to an embodiment, when it is identified that the first distance is smaller than a preset distance, the processor 320 may display the first object representing the first application on the second area based on identifying that the third user input is released. According to an embodiment, when it is identified that the first distance is smaller than the preset distance, the processor 320 may display the first object representing the first application in a three-dimensional shape (e.g., a 3D object) on the second area. For example, the preset distance may include a distance for displaying the first object representing the first application instead of the first execution screen of the first application at the position where the third user input is identified. According to an embodiment, when a user input on the first object displayed on the second area is identified, the processor 320 may display the first window including the first execution screen of the first application with a preset attribute on the second area. For example, the preset attribute may include the at least one attribute of the first execution screen when an input for determining the attribute of the first execution screen is not identified.

According to an embodiment, when the third user input is not identified after the second user input, the processor 320 may display the first window including the first execution screen of the first application with the preset attribute on the second area at a time when the second user input is identified as released. For example, the preset attribute may include the at least one attribute of the first execution screen when an input for determining the attribute of the first execution screen is not identified.

According to an embodiment, the processor 320 may identify a fourth user input to select a second object representing a second application included in the user interface while the third user input is maintained. According to an embodiment, the fourth user input may include a long press input or a long press gesture.

According to an embodiment, the processor 320 may identify that at least one of the third user input or the fourth user input is released. According to an embodiment, the processor 320 may execute the second application based on at least one of the third user input or the fourth user input being released. According to an embodiment, the processor 320 may display a second window including a second execution screen of the second application on the second area based on the at least one attribute determined based on the third user input. According to an embodiment, the processor 320 may display the second window including the second execution screen instead of the first window including the first execution screen on the second area. According to an embodiment, the processor 320 may display the second window including the second execution screen having the determined attribute of the first execution screen on the second area.

According to an embodiment, after displaying the first window on the second area, the processor 320 may identify a command to display a second execution screen of a second application on a third area of the display areas of the display 360. According to an embodiment, the processor 320 may identify a fourth user input to select a second object representing a second application included in the user interface. According to an embodiment, the processor 320 may identify a fifth user input to select a position to display the second execution screen on the third area while the fourth user input is maintained. According to an embodiment, the processor 320 may identify a sixth user input that is consecutive to the fifth user input while the fifth user input is maintained (or not released). According to an embodiment, the fifth user input may include a long press input or a long press gesture. According to an embodiment, the sixth user input may include a swipe, a drag, a pinch, a pinch in, or a pinch out input (or gesture). According to an embodiment, the processor 320 may determine at least one attribute of the second execution screen based on the sixth user input. For example, the at least one attribute of the second execution screen may include the size of the second execution screen. According to an embodiment, the electronic device 301 may identify a second distance between a third position and a fourth position where the sixth user input is identified. According to an embodiment, the electronic device 301 may determine the size of the second execution screen corresponding to the second distance. According to an embodiment, when the sixth user input is released, the processor 320 may display a second window including the second execution screen on the third area. According to an embodiment, when it is identified that a portion of the first window and a portion of the second window overlap, the processor 320 may adjust a display position (or arrangement) of at least one of the first window or the second window so that the first window and the second window do not overlap. According to an embodiment, when it is identified that the portion of the first window and the portion of the second window do not overlap, the processor 320 may display the first window and the second window at the corresponding positions without adjusting the display positions of the first window and the second window.

According to an embodiment, the portion of the first window may be displayed on the portion of the second window. According to an embodiment, when a user input on the portion of the first window is identified for a preset time, the processor 320 may display the portion of the second window on the portion of the first window. According to an embodiment, when a user input on the portion of the second window is identified for the preset time, the processor 320 may display the portion of the second window on the portion of the first window.

According to an embodiment, after displaying the first window on the second area, the processor 320 may identify a command to display a second execution screen of a second application on the second area of the display areas of the display 360. According to an embodiment, the processor 320 may identify a fourth user input to select the second object. According to an embodiment, the processor 320 may identify a fifth user input to select a position to display the second execution screen on the second area while the fourth user input is maintained (or not released). According to an embodiment, when it is identified that the fifth user input is released, the processor 320 may divide and display a portion of the first execution screen and a portion of the second execution screen in one window. According to an embodiment, a first size of the portion of the first execution screen and a second size of the portion of the second execution screen may be identical to each other. According to an embodiment, the first size of the portion of the first execution screen and the second size of the portion of the second execution screen may be different from each other.

According to an embodiment, the processor 320 may display the first window of the first size. According to an embodiment, the processor 320 may display a second window of the second size. According to an embodiment, the first size and the second size may be different from each other. According to an embodiment, the processor 320 may identify a sixth user input to select a third object representing a third application included in the user interface. For example, the sixth user input may include a long press input. According to an embodiment, the processor 320 may identify a seventh user input to select a position to display a third execution screen of the third application on a fourth area of the display areas of the display 360. For example, the seventh user input may include a long press input or a long press gesture. According to an embodiment, the processor 320 may compare the first size and the second size based on the seventh user input. According to an embodiment, when it is identified that the first size is larger than the second size, the processor 320 may display a third window including the third execution screen with the first size at a time when the seventh user input is released. According to an embodiment, when it is identified that the first size is larger than the second size, the processor 320 may display the third window including the third execution screen with the second size when the seventh user input is released.

According to an embodiment, the processor 320 may identify a second user input to select a position to display the first window on the second area while the first user input to select the first object is maintained. For example, the second user input may include a long press input or a long press gesture. According to an embodiment, when the second user input is released, the processor 320 may display the first window including the first execution screen of the first application with a preset size on the second area. For example, the preset size may include the size of the first execution screen when an input for determining the size of the first execution screen is not identified.

According to an embodiment, the processor 320 may identify a user input swiping a second object representing a second application included in the user interface. According to an embodiment, the processor 320 may identify a speed and a direction of the user input swiping the second object. According to an embodiment, the processor 320 may determine a display position of a second window including a second execution screen of the second application based on the speed and the direction of the user input swiping the second object. According to an embodiment, the display position of the second window corresponding to the speed and the direction of the user input may be preset. According to an embodiment, the processor 320 may determine the display position and the attribute of the second window including the second execution screen of the second application based on the speed and the direction of the user input swiping the second object. According to an embodiment, the display position and the attribute of the second window corresponding to the speed and the direction of the user input may be preset.

According to an embodiment, the first area of the display 360 where the user interface is displayed may include a lower area of the display 360. According to an embodiment, the processor 320 may identify that the direction of the user input swiping the second object is a first direction moving from bottom to top, and the speed is a first speed. According to an embodiment, the processor 320 may determine the display position of the second window as a first position corresponding to the first speed. According to an embodiment, the larger the speed of the user input swiping the second object, the greater the distance between the display position of the second window and the position where the user interface is displayed. According to an embodiment, the processor 320 may determine the display position of the second window as the first position corresponding to the first speed and adjust the size, transparency, color, depth, or brightness of the second window to correspond to the first speed.

According to an embodiment, the first area of the display 360 where the user interface is displayed may include an upper area of the display 360. According to an embodiment, the processor 320 may identify that the direction of the user input swiping the second object is the first direction moving from top to bottom, and the speed is the first speed. According to an embodiment, the processor 320 may determine the display position of the second window as the first position corresponding to the first speed. According to an embodiment, the processor 320 may determine the display position of the second window as the first position corresponding to the first speed and adjust the size, transparency, color, depth, or brightness of the second window to correspond to the first speed. However, this is an example, and the first area of the display 360 may not be limited to the examples.

Operations of the electronic device 301 may be performed by the processor 320. However, for convenience of description, operations performed by the processor 320 may be described as being performed by the electronic device 301 (e.g., under control of the processor).

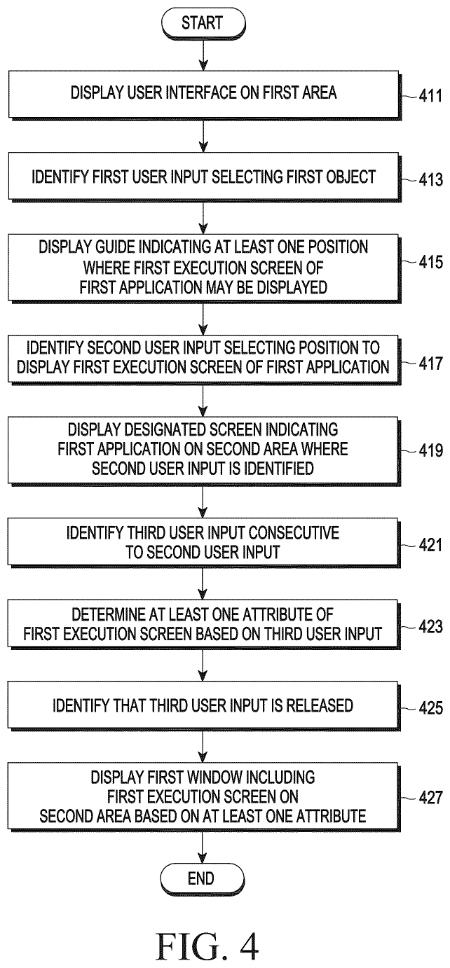

FIG. 4 is a flowchart illustrating an example operation of an electronic device displaying a first window based on at least one determined attribute according to one or more embodiments.

Referring to FIG. 4, according to an embodiment, in operation 411, the electronic device 301 (e.g., the electronic device 301 of FIG. 3) may display a user interface on a first area among display areas of the display 360 (e.g., the display 360 of FIG. 3). According to an embodiment, the user interface may include at least one object representing at least one application. For example, the at least one object representing the at least one application may include an object (e.g., an icon and/or content) for executing the at least one application.

According to an embodiment, in operation 413, the electronic device 301 may identify a first user input to select a first object included in the user interface. According to an embodiment, the first user input may include a touch input, a touch gesture, a long press input, or a long press gesture. According to an embodiment, the first object may include an object representing a first application.

According to an embodiment, in operation 415, the electronic device 301 may display a guide representing at least one position where the first execution screen of the first application may be displayed among the display areas of the display 360. According to an embodiment, positions where execution screens of a plurality of applications may be displayed may be different for each of the plurality of applications.

According to an embodiment, in operation 417, the electronic device 301 may identify a second user input to select a position to display the first execution screen of the first application on a second area of the display areas of the display 360 while the first user input is maintained. According to an embodiment, the second user input may include a touch input, a touch gesture, a long press input, or a long press gesture.

According to an embodiment, in operation 419, the electronic device 301 may display a designated screen representing the first application on the second area where the second user input is identified. According to an embodiment, the designated screen representing the first application may include a screen including the first object or a screen designated by the user. According to an embodiment, the electronic device 301 may apply a visual effect to the designated screen representing the first application and display it on the second area where the second user input is identified. For example, the visual effect may include an effect of adjusting a color or a transparency of the designated screen.

According to an embodiment, in operation 421, the electronic device 301 may identify a third user input that is consecutive to the second user input while the second user input is not released. According to an embodiment, the electronic device 301 may identify the third user input on the second area. According to an embodiment, the electronic device 301 may identify the third user input as an input consecutive to the second user input when the third user input is identified within a preset time from when the second user input is identified. For example, the preset time may represent a time during which the third user input is identified as the input consecutive to the second user input.

According to an embodiment, the third user input may include a pinch, a pinch in, or a pinch out input (or gesture). According to an embodiment, the third user input may include a swipe or a drag input (or gesture).

According to an embodiment, in operation 423, the electronic device 301 may determine at least one attribute of the first execution screen based on the third user input. According to an embodiment, the at least one attribute may include at least one of a size, a transparency, a color, a depth, or a brightness of the first execution screen.

According to an embodiment, the electronic device 301 may identify a distance between positions where the third user input is identified.

According to an embodiment, the electronic device 301 may identify a first distance between a first position and a second position where the third user input including a pinch, a pinch in, or a pinch out input is identified. According to an embodiment, the electronic device 301 may identify a first distance between a first position and a second position where the third user input representing a swipe input or a drag input is identified. For example, the first position where the third user input including the swipe input or the drag input is identified may represent a start point of the third user input, and the second position where the third user input including the swipe input or the drag input is identified may represent an end point of the third user input.

According to an embodiment, the electronic device 301 may determine the at least one attribute corresponding to the direction of the third user input or the first distance. According to an embodiment, the attribute corresponding to the direction of the third user input or the distance between the positions where the third user input is identified may be preset by the user or the electronic device 301.

For example, when the third user input is identified as an input swiping or dragging from bottom to top, the electronic device 301 may determine that the larger the first distance, the larger the size, the transparency, or the brightness of the first execution screen. For example, when the third user input is identified as an input swiping or dragging from top to bottom, the electronic device 301 may determine that the larger the first distance, the larger the size, the transparency, or the brightness of the first execution screen. For example, when the third user input is identified as a pinch in or a pinch out input, the electronic device 301 may determine that the larger the first distance, the larger the size, the transparency, or the brightness of the first execution screen.

According to an embodiment, in operation 425, the electronic device 301 may identify that the third user input is released. According to an embodiment, the electronic device 301 may execute the first application based on the third user input being released.

According to an embodiment, in operation 427, the electronic device 301 may display the first window including the first execution screen on the second area based on the determined at least one attribute. According to an embodiment, the electronic device 301 may display the first window including the first execution screen having the attribute corresponding to the direction of the third user input or the first distance on the second area.

According to an embodiment, when it is identified that the third user input is not released, the electronic device 301 may not execute the first application. According to an embodiment, the electronic device 301 may display a guide (e.g., a designated screen related to the first application) for determining the attribute of the first application without executing the first application.

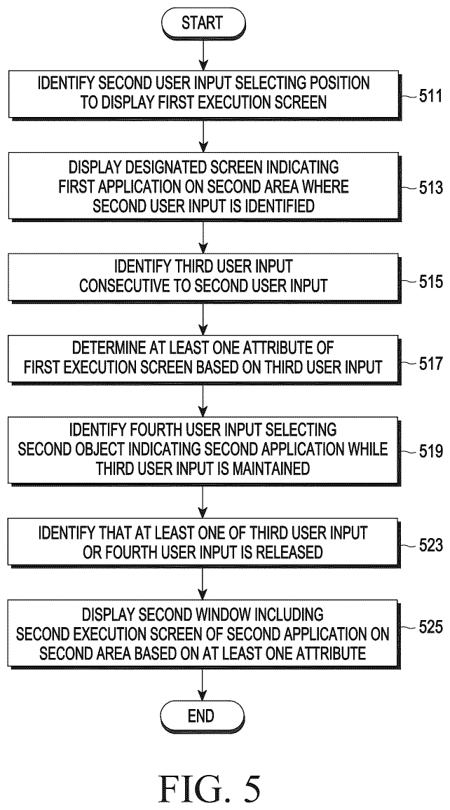

FIG. 5 is a flowchart illustrating an example operation of an electronic device displaying a second window based on at least one determined attribute according to one or more embodiments.

Referring to FIG. 5, according to an embodiment, in operation 511, the electronic device 301 (e.g., the electronic device 301 of FIG. 3) may identify a second user input to select a position to display a first execution screen. According to an embodiment, the second user input may include a long press input.

According to an embodiment, in operation 513, the electronic device 301 may display a designated screen representing the first application on the second area where the second user input is identified.

According to an embodiment, in operation 515, the electronic device 301 may identify a third user input that is consecutive to the second user input while the second user input is not released. According to an embodiment, the second user input may include a touch input, a touch gesture, a long press input, or a long press gesture. According to an embodiment, the third user input may include a pinch input, a pinch gesture, a pinch in input, a pinch in gesture, a pinch out input, or a pinch out gesture. According to an embodiment, the third user input may include a swipe input, a drag input, a swipe gesture, or a drag gesture.

According to an embodiment, in operation 517, the electronic device 301 may determine at least one attribute of the first execution screen based on the third user input.

According to an embodiment, in operation 519, the electronic device 301 may identify a fourth user input to select a second object representing a second application included in the user interface while the third user input is maintained. According to an embodiment, the fourth user input may include a long press input. For example, the second object may include an object (e.g., an icon and/or content) capable of executing the second application.

According to an embodiment, in operation 523, the electronic device 301 may identify that at least one of the third user input or the fourth user input is released. According to an embodiment, the electronic device 301 may execute the second application based on at least one of the third user input or the fourth user input being released.

According to an embodiment, in operation 525, the electronic device 301 may display a second window including a second execution screen of the second application on the second area based on the at least one attribute. According to an embodiment, the electronic device 301 may display the second window on the second area based on the at least one attribute of the first execution screen determined based on the third user input. According to an embodiment, the electronic device 301 may display the second window including the second execution screen instead of the first window including the first execution screen on the second area.

According to an embodiment, when it is identified that the third user input and the fourth user input are not released, the electronic device 301 may not execute the second application. According to an embodiment, the electronic device 301 may display a guide (e.g., a designated screen related to the second application) for determining the attribute of the second application without executing the second application.

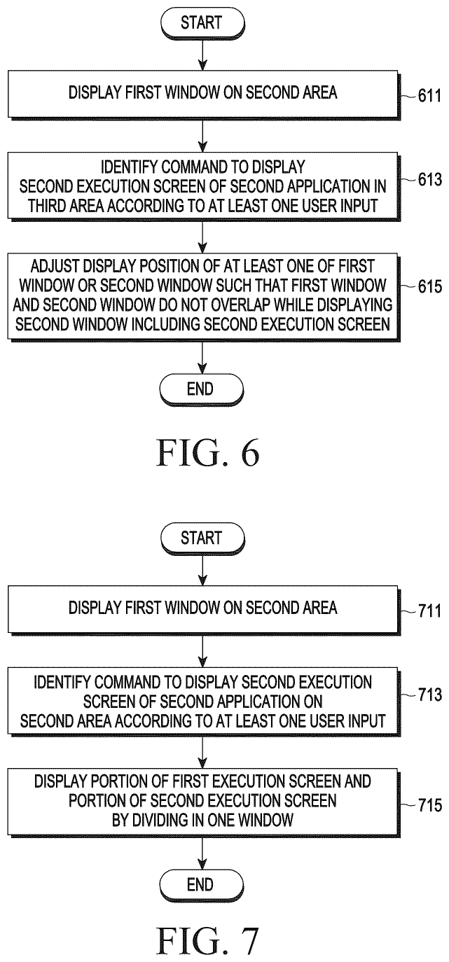

FIG. 6 is a flowchart illustrating an example operation of an electronic device adjusting a display position of at least one of a first window or a second window according to one or more embodiments.

Referring to FIG. 6, according to an embodiment, in operation 611, the electronic device 301 (e.g., the electronic device 301 of FIG. 3) may display a first window including a first execution screen of a first application on a second area.

According to an embodiment, in operation 613, the electronic device 301 may identify a command to display a second execution screen of a second application on a third area of the display areas of the display 360 (e.g., the display 360 of FIG. 3) according to at least one user input. According to an embodiment, the electronic device 301 may identify a fourth user input to select a second object representing a second application included in the user interface. According to an embodiment, the fourth user input may include a touch input, a touch gesture, a long press input, or a long press gesture. According to an embodiment, the electronic device 301 may identify a fifth user input to select a position to display the second execution screen of the second application on the third area while the fourth user input is not released. According to an embodiment, the fifth user input may include a touch input, a touch gesture, a long press input, or a long press gesture. According to an embodiment, the electronic device 301 may identify a sixth user input that is consecutive to the fifth user input while the fifth user input is not released. According to an embodiment, the sixth user input may include a pinch input, a pinch gesture, a pinch in input, a pinch in gesture, a pinch out input, or a pinch out gesture. According to an embodiment, the sixth user input may include a swipe input, a swipe gesture, a drag input, or a drag gesture.

According to an embodiment, the electronic device 301 may determine at least one attribute of the second execution screen based on the sixth user input. For example, the at least one attribute of the second execution screen may include the size of the second execution screen. According to an embodiment, the electronic device 301 may identify a second distance between a third position and a fourth position where the sixth user input representing a pinch input is identified. According to an embodiment, the electronic device 301 may determine the size of the second execution screen corresponding to the second distance.

According to an embodiment, in operation 615, the electronic device 301 may adjust a display position of at least one of the first window or the second window so that the first window and the second window do not overlap while displaying the second window including the second execution screen. According to an embodiment, when the sixth user input is released, the electronic device 301 may display the second window including the second execution screen on the third area. According to an embodiment, the electronic device 301 may identify a display position of the first window and a display position of the second window. According to an embodiment, when it is identified that a portion of the first window and a portion of the second window overlap, the electronic device 301 may adjust the display position of at least one of the first window or the second window so that the first window and the second window do not overlap. According to an embodiment, when it is identified that the portion of the first window and the portion of the second window do not overlap, the electronic device 301 may not adjust the display positions of the first window and the second window.

FIG. 7 is a flowchart illustrating an example operation of an electronic device dividing and displaying a portion of a first execution screen and a portion of a second execution screen in one window according to one or more embodiments.

According to an embodiment, in operation 711, the electronic device 301 (e.g., the electronic device 301 of FIG. 3) may display a first window including a first execution screen of a first application on a second area of the display areas of the display 360 (e.g., the display 360 of FIG. 3).

According to an embodiment, in operation 713, the electronic device 301 may identify a command to display a second execution screen of a second application on the second area of the display areas of the display 360 according to at least one user input. According to an embodiment, the electronic device 301 may identify a fourth user input to select a second object representing a second application included in the user interface. According to an embodiment, the fourth user input may include a touch input, a touch gesture, a long press input, or a long press gesture. According to an embodiment, the electronic device 301 may identify a fifth user input to select a position to display the second execution screen on the second area of the display areas of the display 360. According to an embodiment, the fifth user input may include a touch input, a touch gesture, a long press input, or a long press gesture.

According to an embodiment, in operation 715, when it is identified that the fifth user input is released, the electronic device 301 may divide and display a portion of the first execution screen and a portion of the second execution screen in one window. According to an embodiment, a first size of the portion of the first execution screen and a second size of the portion of the second execution screen may be identical to each other. According to an embodiment, the first size of the portion of the first execution screen and the second size of the portion of the second execution screen may be different from each other.

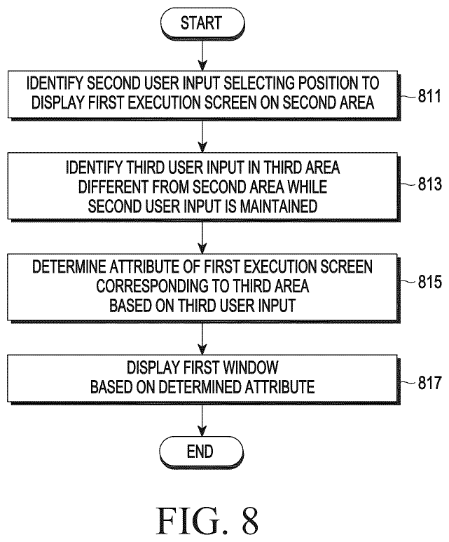

FIG. 8 is a flowchart illustrating an example operation of an electronic device determining an attribute of a first execution screen corresponding to a third area where a third user input is identified according to one or more embodiments.

Referring to FIG. 8, according to an embodiment, in operation 811, the electronic device 301 (e.g., the electronic device 301 of FIG. 3) may identify a second user input to select a position to display a first execution screen of a first application on a second area. According to an embodiment, the second user input may include a touch input, a touch gesture, a long press input, or a long press gesture.

According to an embodiment, in operation 813, the electronic device 301 may identify a third user input on a third area different from the second area while the second user input is maintained. According to an embodiment, the third user input may include an input consecutive to the second user input. According to an embodiment, the electronic device 301 may identify the third user input as an input consecutive to the second user input when the third user input is identified within a preset time from when the second user input is identified. According to an embodiment, the third user input may include a swipe input or a drag input.

According to an embodiment, in operation 815, the electronic device 301 may determine an attribute of the first execution screen corresponding to the third area based on the third user input. According to an embodiment, a plurality of areas may be set to adjust the attribute of the first execution screen. For example, the attribute of the first execution screen corresponding to the second area may include a first attribute (e.g., size). For example, the attribute of the first execution screen corresponding to the third area may include a second attribute (e.g., transparency) different from the first attribute.

According to an embodiment, the electronic device 301 may identify the direction and the moving distance of the third user input. According to an embodiment, the electronic device 301 may adjust the transparency of the first execution screen based on the direction and the moving distance of the third user input. According to an embodiment, the transparency corresponding to the direction and the moving distance of the third user input may be set by the user or the electronic device 301.

For example, when the third user input is a swipe input moving from bottom to top, the larger the moving distance of the third user input, the greater the transparency of the first execution screen.

For example, when the third user input is a swipe input moving from top to bottom, the larger the moving distance of the third user input, the smaller the transparency of the first execution screen.

According to an embodiment, in operation 817, the electronic device 301 may display a first window based on the determined attribute.

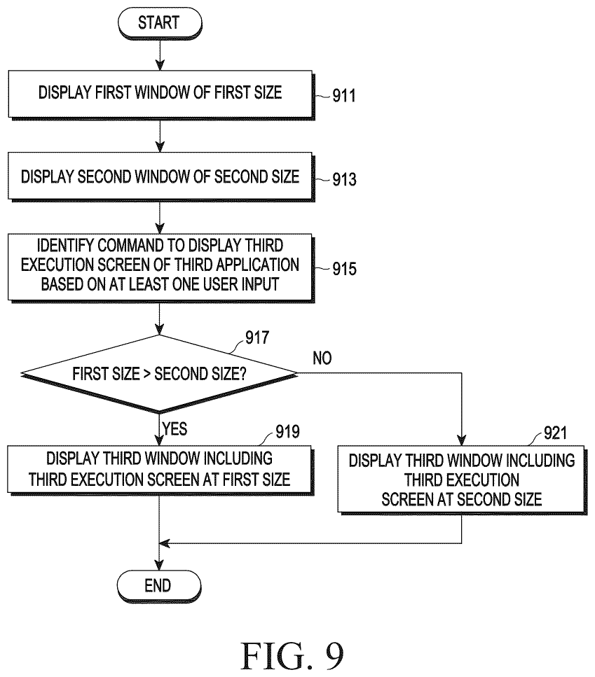

FIG. 9 is a flowchart illustrating an example operation of an electronic device determining a size of a window according to one or more embodiments.

Referring to FIG. 9, in operation 911, the electronic device 301 (e.g., the electronic device 301 of FIG. 3) may display a first window including a first execution screen of a first application of a first size.

According to an embodiment, in operation 913, the electronic device 301 may display a second window including a second execution screen of a second application of a second size. According to an embodiment, the first size and the second size may be different from each other.

According to an embodiment, in operation 915, the electronic device 301 may identify a command to display a third execution screen of a third application based on at least one user input. According to an embodiment, the electronic device 301 may identify a user input (e.g., a long press input or a long press gesture) to select a third object representing a third application included in the user interface. According to an embodiment, the electronic device 301 may identify a user input (e.g., a long press input) to select a position to display the third execution screen on a fourth area of the display areas of the display 360 (e.g., the display 360 of FIG. 3).

According to an embodiment, in operation 917, the electronic device 301 may compare the first size and the second size.

According to an embodiment, when it is identified that the first size is larger than the second size (operation 917—YES), in operation 919, the electronic device 301 may display a third window including the third execution screen with the first size. According to an embodiment, the electronic device 301 may identify that the user input (e.g., a long press input or a long press gesture) to select the position to display the third execution screen is released. According to an embodiment, the electronic device 301 may display the third window including the third execution screen with the first size at a time when the user input to select the position to display the third execution screen is released.

According to an embodiment, when it is identified that the first size is not larger than the second size (operation 917—NO), in operation 921, the electronic device 301 may display the third window including the third execution screen with the second size. According to an embodiment, the electronic device 301 may display the third window including the third execution screen with the second size at a time when the user input to select the position to display the third execution screen is identified as released.

According to an embodiment, when it is identified that the first size is larger than the second size, the electronic device 301 may display the third window including the third execution screen with the second size at a time when the user input to select the position to display the third execution screen is identified as released.

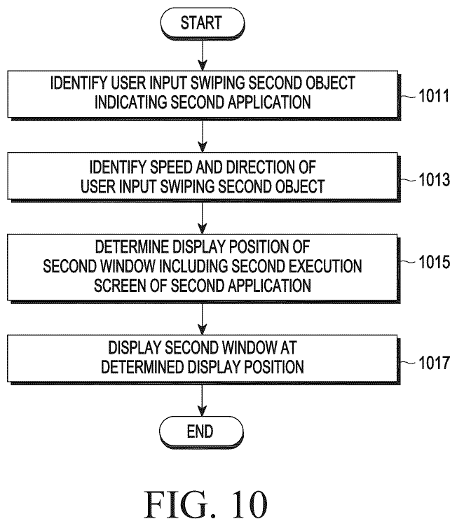

FIG. 10 is a flowchart illustrating an example operation of an electronic device determining a display position of a second window based on a speed and a direction of a user input according to one or more embodiments.

Referring to FIG. 10, according to an embodiment, in operation 1011, the electronic device 301 (e.g., the electronic device 301 of FIG. 3) may identify a user input (e.g., a swipe input or a swipe gesture) swiping a second object representing a second application included in the user interface.

According to an embodiment, in operation 1013, the electronic device 301 may identify a speed and a direction of the user input swiping the second object.

According to an embodiment, in operation 1015, the electronic device 301 may determine a display position of a second window including a second execution screen of the second application based on the speed and the direction of the user input swiping the second object.

According to an embodiment, the user interface may be displayed on a first area of the display 360 (e.g., the display 360 of FIG. 3). According to an embodiment, the first area of the display 360 may include a lower area of the display 360. According to an embodiment, the electronic device 301 may identify that the direction of the user input is a first direction moving from bottom to top and the speed of the user input is a first speed. According to an embodiment, the electronic device 301 may determine the display position of the second window as the first position corresponding to the first speed. According to an embodiment, the position corresponding to the speed of the user input may be set by the user or the electronic device 301. According to an embodiment, the larger the speed of the user input, the greater the distance between the display position of the second window and the position where the user interface is displayed.

According to an embodiment, the first area of the display 360 may include an upper area of the display 360. According to an embodiment, the electronic device 301 may identify that the direction of the user input is a second direction moving from top to bottom and the speed of the user input is the first speed. According to an embodiment, the electronic device 301 may determine the display position of the second window as the first position corresponding to the first speed. However, this is an example, and the first area of the display 360 may not be limited to the examples.

According to an embodiment, in operation 1017, the electronic device 301 may display the second window at the determined display position.

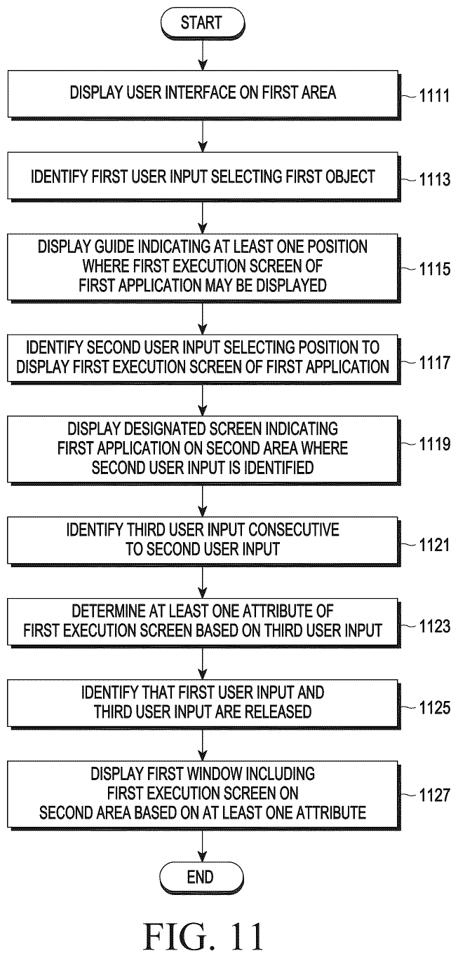

FIG. 11 is a flowchart illustrating an example operation of an electronic device displaying a first window based on at least one determined attribute according to one or more embodiments.

Referring to FIG. 11, according to an embodiment, in operation 1111, the electronic device 301 (e.g., the electronic device 301 of FIG. 3) may display a user interface on a first area among display areas of the display 360 (e.g., the display 360 of FIG. 3). According to an embodiment, the user interface may include at least one object representing at least one application. For example, the at least one object representing the at least one application may include an object (e.g., an icon and/or content) capable of executing the at least one application.

According to an embodiment, in operation 1113, the electronic device 301 may identify a first user input to select a first object included in the user interface. According to an embodiment, the first user input may include a touch input, a touch gesture, a long press input, or a long press gesture. According to an embodiment, the first object may include an object representing a first application.

According to an embodiment, in operation 1115, the electronic device 301 may display a guide representing at least one position where the first execution screen of the first application may be displayed among the display areas of the display 360.

According to an embodiment, in operation 1117, the electronic device 301 may identify a second user input to select a position to display the first execution screen of the first application on a second area of the display areas of the display 360 while the first user input is maintained. According to an embodiment, the second user input may include a touch input, a touch gesture, a long press input, or a long press gesture.

According to an embodiment, in operation 1119, the electronic device 301 may display a designated screen representing the first application on the second area where the second user input is identified. According to an embodiment, the designated screen representing the first application may include a screen including the first object or a screen set by the user. According to an embodiment, the designated screen representing the first application may include an execution screen of the first application. According to an embodiment, the electronic device 301 may apply a visual effect to the designated screen representing the first application and display it on the second area where the second user input is identified. For example, the visual effect may include an effect of adjusting a color or a transparency of the designated screen.

According to an embodiment, in operation 1121, the electronic device 301 may identify a third user input that is consecutive to the second user input while the second user input is not released. According to an embodiment, the electronic device 301 may identify the third user input on the second area. According to an embodiment, the electronic device 301 may identify the third user input as an input consecutive to the second user input when the third user input is identified within a preset time from when the second user input is identified. According to an embodiment, the third user input may include a pinch input, a pinch gesture, a pinch in input, a pinch in gesture, a pinch out input, or a pinch out gesture. According to an embodiment, the third user input may include a swipe input, a swipe gesture, a drag input, or a drag gesture.

According to an embodiment, in operation 1123, the electronic device 301 may determine at least one attribute of the first execution screen based on the third user input. According to an embodiment, the at least one attribute may include at least one of a size, a transparency, a color, or a brightness of the first execution screen. According to an embodiment, the electronic device 301 may identify a distance between positions where the third user input is identified. According to an embodiment, the electronic device 301 may identify a first distance between a first position and a second position where the third user input is identified. According to an embodiment, the electronic device 301 may determine the at least one attribute corresponding to the first distance. According to an embodiment, the attribute corresponding to the distance between the positions where the third user input is identified may be preset by the user or the electronic device 301.

According to an embodiment, in operation 1125, the electronic device 301 may identify that the first user input and the third user input are released. According to an embodiment, the electronic device 301 may execute the first application based on the first user input and the third user input being released. According to an embodiment, when it is identified that the third user input is released and the first user input is not released, the electronic device 301 may not execute the first application. According to an embodiment, when it is identified that the first user input and the third user input are not released, the electronic device 301 may not execute the first application. According to an embodiment, the electronic device 301 may display a guide (e.g., a designated screen related to the first application) for determining the attribute of the first application without executing the first application.

According to an embodiment, in operation 1127, the electronic device 301 may display a first window including the first execution screen on the second area based on the at least one attribute. According to an embodiment, the electronic device 301 may display the first window on the second area based on the attribute corresponding to the first distance.

According to an embodiment, in FIG. 11 and below, operations performed by the electronic device 301 based on the third user input being released may be redisposed with operations performed by the electronic device 301 based on the first user input and the third user input being released.

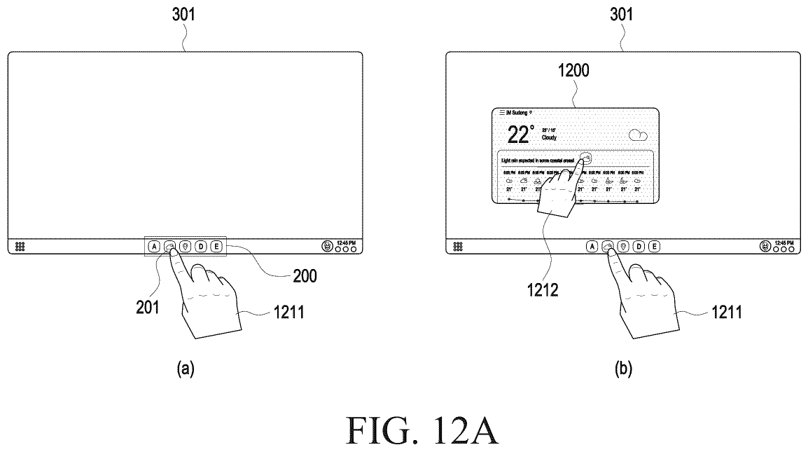

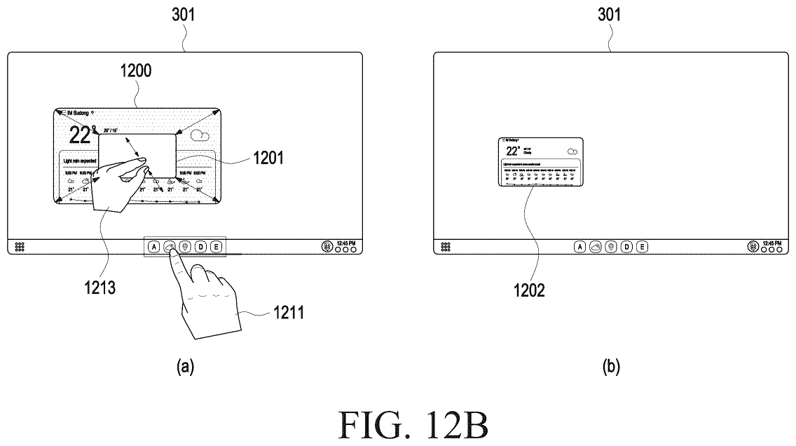

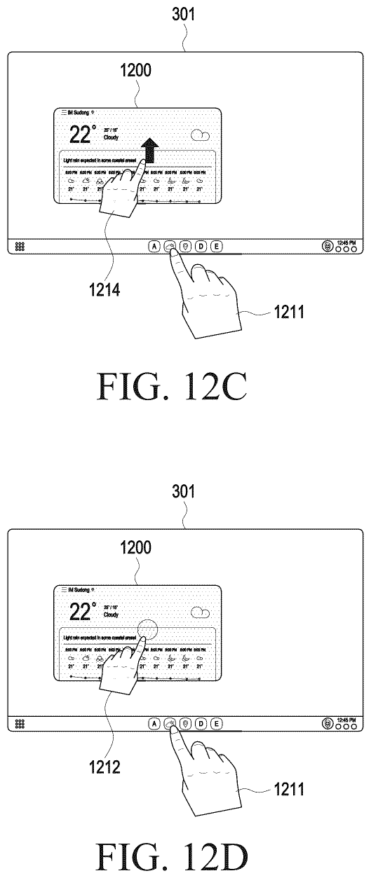

FIG. 12A is a diagram illustrating an example operation of an electronic device identifying a user input to select a position to display a first execution screen according to one or more embodiments.

Referring to (a) of FIG. 12A, according to an embodiment, the electronic device 301 (e.g., the electronic device 301 of FIG. 3) may display a user interface 200 on a first area among display areas of the display 360 (e.g., the display 360 of FIG. 3).

According to an embodiment, the electronic device 301 may identify a first user input 1211 on a first object 201 representing a first application included in the user interface 200. For example, the first object 201 may include an icon capable of executing the first application. According to an embodiment, the first user input 1211 may include a long press input.

Referring to (b) of FIG. 12A, according to an embodiment, the electronic device 301 may identify a second user input 1212 to select a position to display a first execution screen of the first application on a second area while the first user input 1211 is maintained. According to an embodiment, the second user input 1212 may include a long press input.

According to an embodiment, when the second user input 1212 is identified on the second area, the electronic device 301 may display a designated screen 1200 representing the first application on the second area.

FIG. 12B is a diagram illustrating an example operation of an electronic device displaying a first window according to one or more embodiments.

Referring to (a) of FIG. 12B, according to an embodiment, the electronic device 301 (e.g., the electronic device 301 of FIG. 3) may identify a third user input 1213 that is consecutive to the second user input 1212 while the second user input 1212 is not released. According to an embodiment, the third user input 1213 may include a pinch input, a pinch in input, or a pinch out input.

According to an embodiment, the electronic device 301 may determine the size of the first execution screen of the first application based on the third user input 1213. According to an embodiment, the electronic device 301 may display a screen 1201 representing the determined size of the first execution screen on the designated screen 1200 representing the first application.

Referring to (b) of FIG. 12B, according to an embodiment, the electronic device 301 may identify that the third user input 1213 is released. According to an embodiment, the electronic device 301 may display a first window 1202 including the first execution screen of the determined size on the second area.

According to an embodiment, the electronic device 301 may display the first window 1202 including the first execution screen of the determined size on the second area based on the first user input 1211 and the third user input 1213 being released.

FIG. 12C is a diagram illustrating an example operation of an electronic device displaying a first window according to one or more embodiments.

Referring to FIG. 12C, according to an embodiment, the electronic device 301 (e.g., the electronic device 301 of FIG. 3) may identify a third user input 1214 that is consecutive to the second user input 1212 while the second user input 1212 is not released. For example, the third user input 1214 may include a swipe input or a drag input.

According to an embodiment, the electronic device 301 may determine the transparency of the first execution screen of the first application based on the direction and the distance of the third user input 1214. According to an embodiment, a value of the transparency corresponding to the distance and the direction may be preset. For example, the distance of the third user input 1214 may represent a start point and an end point of the third user input 1214.

According to an embodiment, when the moving direction of the third user input 1214 is identified as a direction moving from bottom to top, the electronic device 301 may increase the transparency of the first execution screen from a preset value. For example, the preset value may include the transparency of the first execution screen when an input for determining the transparency of the first execution screen is not identified.

According to an embodiment, when the moving direction of the third user input 1214 is identified as a direction moving from top to bottom, the electronic device 301 may decrease the transparency of the first execution screen from the preset value.

According to an embodiment, the larger the moving distance, the greater the difference between the preset value and the adjusted transparency value.

FIG. 12D is a diagram illustrating an example operation of an electronic device displaying a first window according to one or more embodiments.

Referring to FIG. 12D, according to an embodiment, the electronic device 301 (e.g., the electronic device 301 of FIG. 3) may identify a second user input 1212 to select a position to display a first execution screen of the first application on the second area while the first user input 1211 is maintained. For example, the second user input 1212 may include a long press input.

According to an embodiment, the electronic device 301 may identify that the second user input 1212 is released after the second user input 1212 is maintained for a preset time. For example, the preset time may include a time for determining at least one attribute of the first execution screen.

According to an embodiment, when the second user input 1212 is released, the electronic device 301 may display the first execution screen with the depth, size, transparency, brightness, or color corresponding to the preset time.

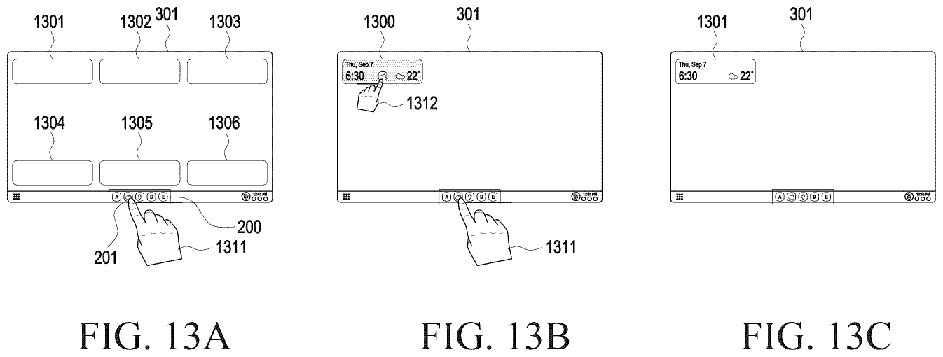

FIGS. 13A, 13B and 13C are diagrams illustrating an example operation of an electronic device displaying a guide representing at least one position where a first execution screen of a first application may be displayed according to one or more embodiments.

Referring to FIG. 13A, according to an embodiment, the electronic device 301 (e.g., the electronic device 301 of FIG. 3) may identify a first user input 1311 on a first object 201 representing a first application included in the user interface 200. According to an embodiment, the first user input 1311 may include a long press input.

According to an embodiment, when the first user input 1311 is identified, the electronic device 301 may display a guide 1301, 1302, 1303, 1304, 1305, 1306 representing at least one position where the first execution screen of the first application may be displayed among display positions of the display 360 (e.g., the display 360 of FIG. 3).

Referring to FIG. 13B, according to an embodiment, the electronic device 301 may identify a second user input 1312 to select a position to display the first execution screen of the first application on a second area while the first user input 1311 is maintained. According to an embodiment, the second user input 1312 may include a tap input or a long press input.

According to an embodiment, when the second user input 1312 is identified on the second area, the electronic device 301 may display a designated screen 1300 representing the first application on the second area.

Referring to FIG. 13C, when it is identified that the second user input 1312 is released, the electronic device 301 may execute the first application. According to an embodiment, the electronic device 301 may display a first window 1301 including the first execution screen of the first application on the second area. According to an embodiment, the electronic device 301 may display the first window 1301 including the first execution screen of a designated size on the second area. For example, the designated size may include the size of the first execution screen when an input for determining the size of the first execution screen is not identified.

According to an embodiment, the electronic device 301 may display the first window 1301 on the second area based on the first user input 1311 and the second user input 1312 being released.

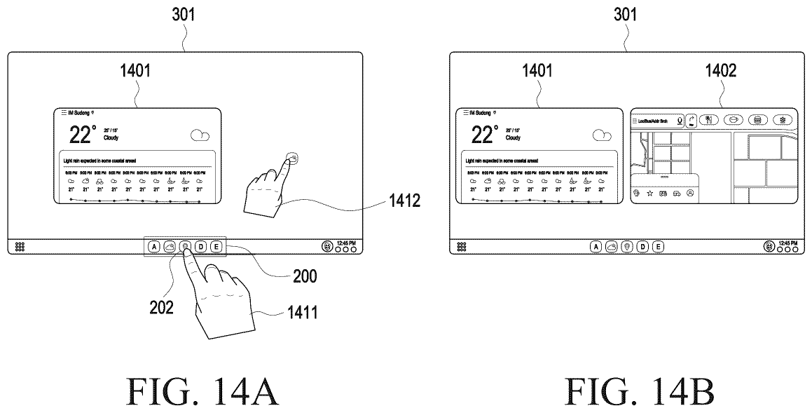

FIGS. 14A and 14B are diagrams illustrating an example operation of an electronic device adjusting display positions of a plurality of windows according to one or more embodiments.

Referring to FIG. 14A, according to an embodiment, the electronic device 301 (e.g., the electronic device 301 of FIG. 3) may display a first window 1401 including a first execution screen of a first application on a second area of the display 360 (e.g., the display 360 of FIG. 3).

According to an embodiment, the electronic device 301 may identify a fourth user input 1411 on a second object 202 representing a second application included in the user interface 200.

According to an embodiment, the electronic device 301 may identify a fifth user input 1412 to select a position to display a second execution screen of the second application on a third area while the fourth user input 1411 is maintained. According to an embodiment, the fifth user input 1412 may include a long press input.

Referring to FIG. 14B, according to an embodiment, when the fifth user input 1412 is released, the electronic device 301 may adjust at least one of the display position of the first window 1401 or a display position of a second window 1402 so that the first window 1401 and the second window 1402 including the second execution screen do not overlap, and display the first window 1401 and the second window 1402.

According to an embodiment, the size of the first window 1401 and the size of the second window 1402 may be identical to each other.

According to an embodiment, when the fourth user input 1411 and the fifth user input 1412 are released, the electronic device 301 may adjust at least one of the display position of the first window 1401 or the display position of the second window 1402 so that the first window 1401 and the second window 1402 including the second execution screen do not overlap, and display the first window 1401 and the second window 1402.

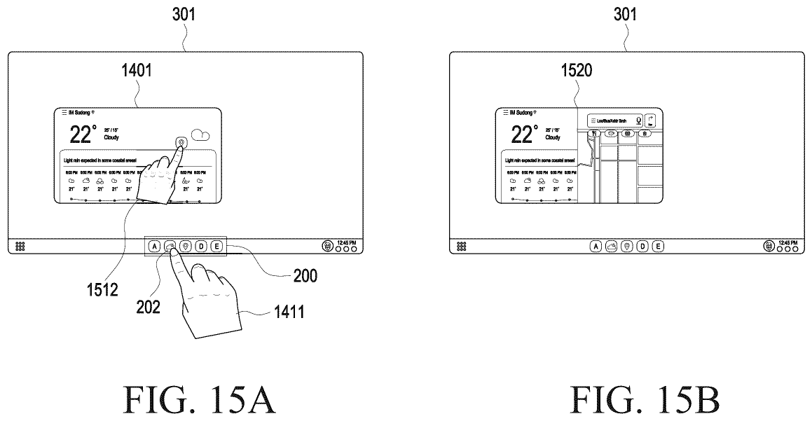

FIGS. 15A and 15B are diagrams illustrating an example operation of an electronic device dividing and displaying a plurality of execution screens in one window according to one or more embodiments.

Referring to FIG. 15A, according to an embodiment, the electronic device 301 (e.g., the electronic device 301 of FIG. 3) may display a first window 1401 including a first execution screen on a second area of the display areas of the display 360 (e.g., the display 360 of FIG. 3).

According to an embodiment, the electronic device 301 may identify a fourth user input 1411 on a second object 202 representing a second application included in the user interface 200.

According to an embodiment, the electronic device 301 may identify a fifth user input 1512 to select a position to display a second execution screen of the second application on the second area while the fourth user input 1411 is maintained. According to an embodiment, the fifth user input 1512 may include a long press input or a tap input.

Referring to FIG. 15B, according to an embodiment, when the fifth user input 1512 is released, the electronic device 301 may divide and display a portion of the first execution screen and a portion of the second execution screen in one window 1520. According to an embodiment, the size of the portion of the first execution screen may be identical to the size of the portion of the second execution screen.

According to an embodiment, when the fourth user input 1411 and the fifth user input 1512 are released, the electronic device 301 may divide and display the portion of the first execution screen and the portion of the second execution screen in one window 1520.

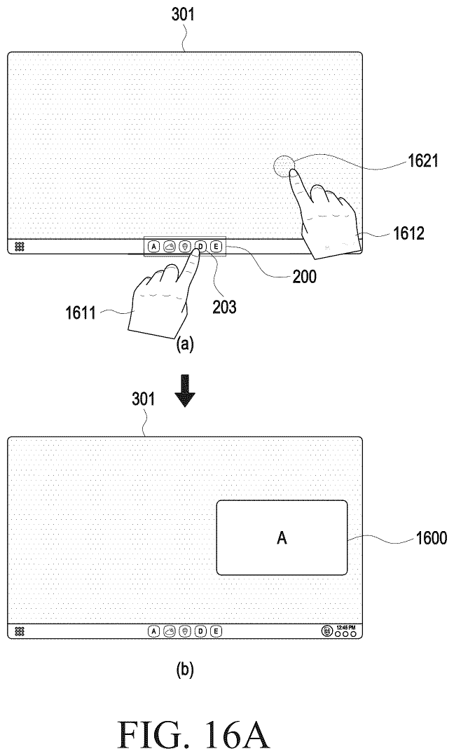

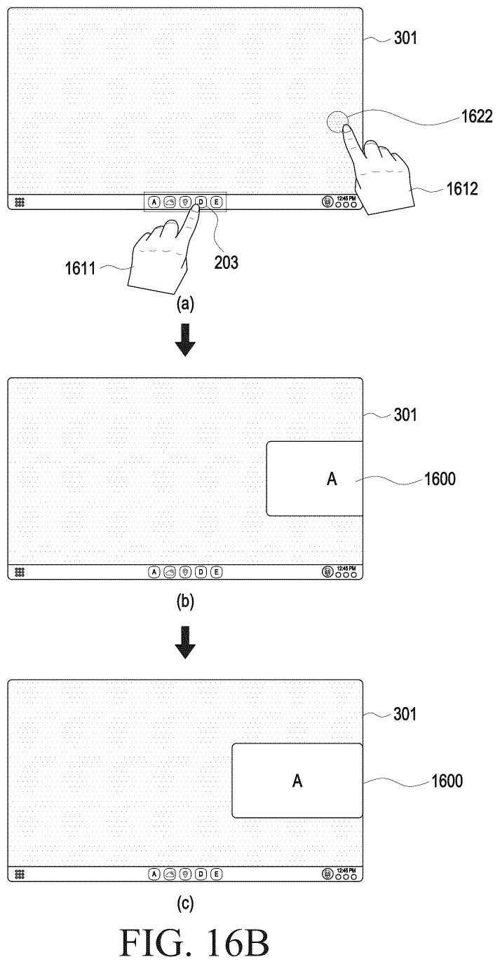

FIG. 16A is a diagram illustrating an example operation of an electronic device displaying a window according to one or more embodiments.

Referring to (a) of FIG. 16A, according to an embodiment, the electronic device 301 (e.g., the electronic device 301 of FIG. 3) may identify a user input 1611 on a third object 203 representing a third application included in the user interface 200. For example, the user input 1611 may include a long press input.

According to an embodiment, the electronic device 301 may identify a user input 1612 to select a position to display a third window 1600 including a third execution screen of the third application while the user input 1611 is maintained. For example, the user input 1612 may include a long press input or a tap input.

According to an embodiment, when the user input 1612 is identified, the electronic device 301 may identify a position 1621 (e.g., coordinates) where the user input 1612 is identified on the display 360 (e.g., the display 360 of FIG. 3) using the sensor 310 (e.g., the sensor 310 of FIG. 3).

Referring to (b) of FIG. 16A, the electronic device 301 may identify that the user input 1612 is released. According to an embodiment, the electronic device 301 may determine the position where the user input 1612 is identified as a center position of the third execution screen.

According to an embodiment, the electronic device 301 may display the third window 1600 including the third execution screen based on the position where the user input 1612 is identified being determined as the center position of the third execution screen.

According to an embodiment, the electronic device 301 may display the third window 1600 based on the user input 1611 and the user input 1612 being released.

FIG. 16B is a diagram illustrating an example operation of an electronic device displaying a window according to one or more embodiments.

Referring to (a) of FIG. 16B, according to an embodiment, the electronic device 301 (e.g., the electronic device 301 of FIG. 3) may identify a user input 1611 on a third object 203 representing a third application included in the user interface 200. For example, the user input 1611 may include a long press input or a tap input.

According to an embodiment, the electronic device 301 may identify a user input 1612 to select a position to display a third window 1600 including a third execution screen of the third application while the user input 1611 is maintained. According to an embodiment, the electronic device 301 may identify a position 1622 where the user input 1612 is received.

Referring to (b) of FIG. 16B, according to an embodiment, the electronic device 301 may determine the position 1622 where the user input 1612 is identified as a center position of the third execution screen. According to an embodiment, based on the position where the user input 1612 is identified being determined as the center position of the third execution screen, at least a portion of the third execution screen may not be displayed.

Referring to (c) of FIG. 16B, according to an embodiment, when it is identified that at least a portion of the third execution screen is not displayed, the electronic device 301 may determine a display position of the third window 1600 so that the entire third execution screen is displayed. According to an embodiment, when the user input 1612 is released, the electronic device 301 may display the third window 1600 including the third execution screen based on the display position determined so that the entire third execution screen is displayed.

According to an embodiment, when the user input 1611 and the user input 1612 are released, the electronic device 301 may display the third window 1600 including the third execution screen based on the display position determined so that the entire third execution screen is displayed.

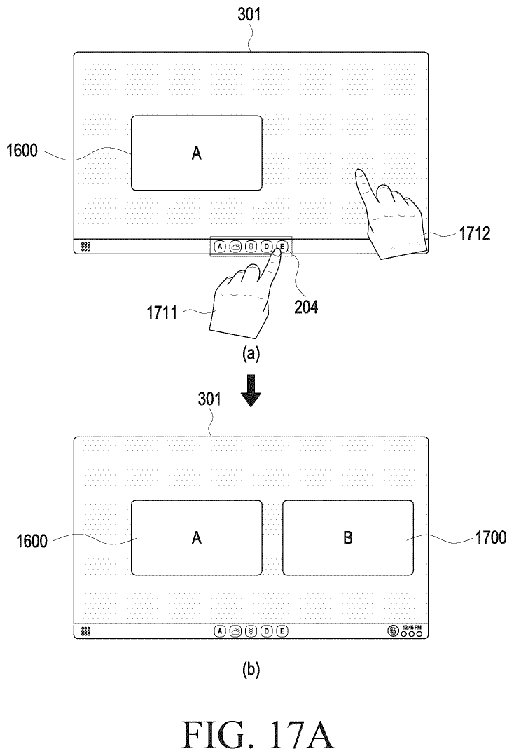

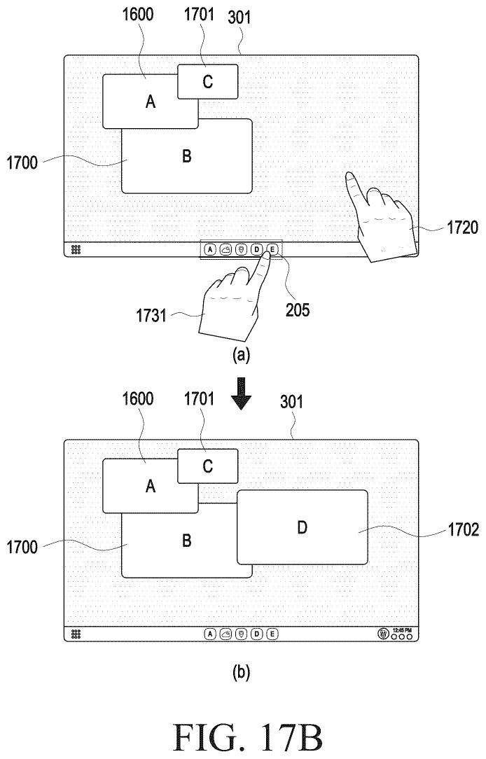

FIG. 17A is a diagram illustrating an example operation of an electronic device determining a size of a window according to one or more embodiments.

Referring to (a) of FIG. 17A, according to an embodiment, the electronic device 301 (e.g., the electronic device 301 of FIG. 3) may display a third window 1600 including a third execution screen of a third application.

According to an embodiment, the electronic device 301 may identify a user input 1711 on a fourth object 204 representing a fourth application. According to an embodiment, the electronic device 301 may identify a user input 1712 to select a position to display a fourth window 1700 including a fourth execution screen of the fourth application while the user input 1711 is maintained.

Referring to (b) of FIG. 17A, according to an embodiment, when it is identified that the user input 1712 is released, the electronic device 301 may display a fourth window 1700 of the same size as the size of the third window 1600.

According to an embodiment, when it is identified that the user input 1711 and the user input 1712 are released, the electronic device 301 may display the fourth window 1700 of the same size as the size of the third window 1600.

FIG. 17B is a diagram illustrating an example operation of an electronic device determining a size of a window according to one or more embodiments.

Referring to (a) of FIG. 17B, according to an embodiment, the electronic device 301 (e.g., the electronic device 301 of FIG. 3) may display a plurality of windows 1600, 1700, 1701.

According to an embodiment, the electronic device 301 may identify a user input 1731 on a fifth object 205 representing a fifth application included in the user interface.

According to an embodiment, the electronic device 301 may identify a user input 1720 to select a position to display a fifth window including a fifth execution screen of the fifth application. For example, the user input 1720 may include a long press input or a tap input.

Referring to (b) of FIG. 17B, according to an embodiment, when the user input 1720 is identified, the electronic device 301 may identify sizes of the plurality of windows 1600, 1700, 1701.

According to an embodiment, the electronic device 301 may identify a largest window size among the sizes of the plurality of windows 1600, 1700, 1701. For example, the electronic device 301 may identify that the size of the fourth window 1700 is the largest among the plurality of windows 1600, 1700, 1701.

According to an embodiment, the electronic device 301 may display a fifth window 1702 having the size of the fourth window 1700 based on identifying that the user input 1720 is released.

According to an embodiment, the electronic device 301 may display the fifth window 1702 having the size of the fourth window 1700 based on identifying that the user input 1731 and the user input 1720 are released.

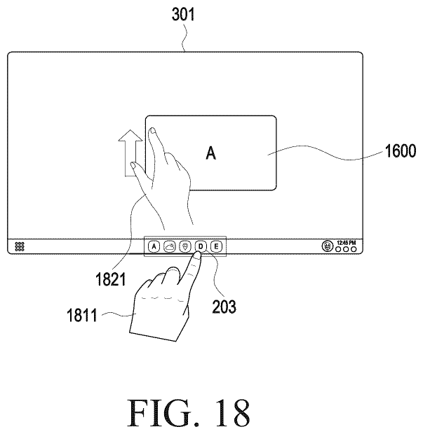

FIG. 18 is a diagram illustrating an example operation of an electronic device determining an attribute of an execution screen based on an area where a user input is identified according to one or more embodiments.

Referring to FIG. 18, the electronic device 301 (e.g., the electronic device 301 of FIG. 3) may identify a user input 1811 on a third object 203 representing a third application included in the user interface 200. For example, the user input 1811 may include a long press input.

According to an embodiment, the electronic device 301 may identify a user input to select a position to display a third window 1600 including a third execution screen of the third application on a second area of the display areas of the display 360 (e.g., the display 360 of FIG. 3) while the user input 1811 is maintained.

According to an embodiment, the electronic device 301 may identify a user input 1821 that is consecutive to the user input to select the position to display the third window 1600 on a third area of the display areas of the display 360 while the user input to select the position to display the third window 1600 is maintained. According to an embodiment, the user input 1821 may include a swipe input or a drag input.

According to an embodiment, the electronic device 301 may determine an attribute of the third execution screen corresponding to the third area based on the user input 1821 being identified on the third area. According to an embodiment, a plurality of areas may be set to adjust the attribute of the third execution screen. For example, the attribute of the third execution screen corresponding to the second area may include size. For example, the attribute of the third execution screen corresponding to the third area may include transparency.

According to an embodiment, when the user input 1821 is identified as an input swiping from bottom to top, the electronic device 301 may increase the transparency of the third execution screen. According to an embodiment, when the user input 1821 is identified as an input swiping from bottom to top, the electronic device 301 may decrease the transparency of the third execution screen.

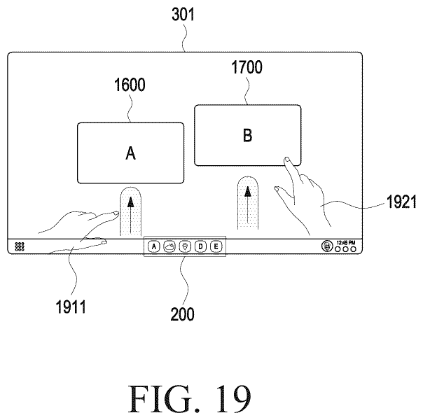

FIG. 19 is a diagram illustrating an example operation of an electronic device determining a position where a window is displayed based on a direction and a speed of a user input according to one or more embodiments.

Referring to FIG. 19, according to an embodiment, the electronic device 301 (e.g., the electronic device 301 of FIG. 3) may identify a user input 1911 on a third object representing a third application included in the user interface 200 and a user input 1921 on a fourth object representing a fourth application included in the user interface 200. The user input 1911 on the third object and the user input 1921 on the fourth object may include a swipe input.

According to an embodiment, the electronic device 301 may identify a moving direction and a moving speed of the user input 1911 on the third object. According to an embodiment, display positions of windows including execution screens corresponding to the moving direction and the moving speed may be preset by the user or automatically set by the electronic device 301. According to an embodiment, display positions and sizes of windows including execution screens corresponding to the moving direction and the moving speed may be preset by the user or automatically set by the electronic device 301.

According to an embodiment, when the user input 1911 on the third object is released, the electronic device 301 may display a third window 1600 including a third execution screen of the third application at a position corresponding to the moving direction and the moving speed of the user input 1911 on the third object. According to an embodiment, when the user input 1911 on the third object is released, the electronic device 301 may display the third window 1600 based on the size and the display position of the window corresponding to the moving direction and the moving speed of the user input 1911 on the third object.

According to an embodiment, when the user input 1921 on the fourth object is released, the electronic device 301 may display a fourth window 1700 including a fourth execution screen of the fourth application at a position corresponding to the moving direction and the moving speed of the user input 1921 on the fourth object. According to an embodiment, when the user input 1921 on the fourth object is released, the electronic device 301 may display the fourth window 1700 based on the size and the display position of the window corresponding to the moving direction and the moving speed of the user input 1921 on the fourth object.

According to an embodiment, the electronic device 301 may identify that the moving direction of the user input 1911 on the third object is a direction moving from bottom to top. According to an embodiment, the electronic device 301 may identify that the moving speed of the user input 1911 on the third object is a first speed. According to an embodiment, the electronic device 301 may display the third window 1600 including the third execution screen of the third application at a position corresponding to the first speed.

According to an embodiment, the electronic device 301 may identify that the moving direction of the user input 1921 on the fourth object is a direction moving from bottom to top. According to an embodiment, the electronic device 301 may identify that the moving speed of the user input 1921 on the third object is a second speed greater than the first speed. According to an embodiment, the electronic device 301 may display the fourth window 1700 at a position corresponding to the second speed.

According to an embodiment, the larger the moving speed of the user input, the greater the distance from the window to the user interface 200.

According to an embodiment, the electronic device 301 may identify a moving direction and a moving distance of the user input 1911 on the third object. According to an embodiment, display positions of windows including execution screens corresponding to the moving direction and the moving distance may be preset by the user or automatically set by the electronic device 301. According to an embodiment, the larger the moving distance of the user input, the greater the distance from the window to the user interface 200.

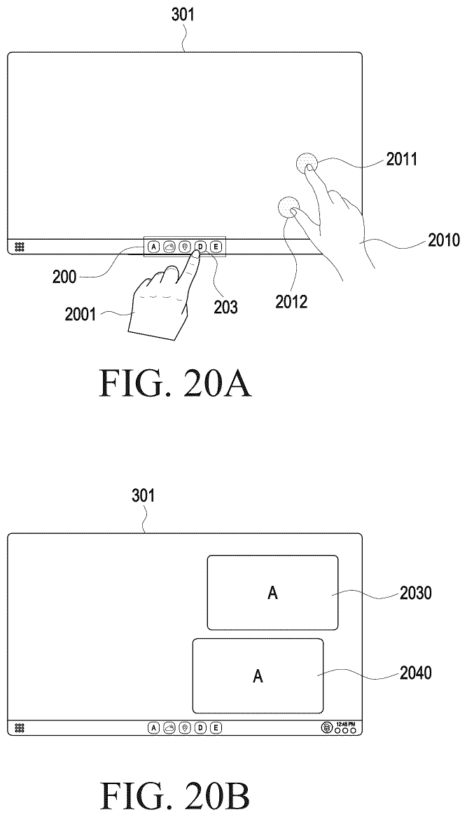

FIGS. 20A and 20B are diagrams illustrating an example operation of an electronic device displaying a plurality of windows according to one or more embodiments.

Referring to FIG. 20A, according to an embodiment, the electronic device 301 (e.g., the electronic device 301 of FIG. 3) may identify a user input 2001 on a third object 203 representing a third application included in the user interface 200. For example, the user input 2001 may include a long press input.

According to an embodiment, the electronic device 301 may identify a user input 2010 to select a position to display an execution screen of the third application while the user input 2001 on the third object 203 is maintained. For example, the user input 2010 may include a pinch input.

According to an embodiment, the electronic device 301 may identify positions 2011, 2012 where the pinch input is identified.

Referring to FIG. 20B, according to an embodiment, the electronic device 301 may identify that the user input 2001 on the third object 203 is released. According to an embodiment, the electronic device 301 may display an execution screen 2030 of the third application based on the first position 2011 where the pinch input is identified. According to an embodiment, the electronic device 301 may display an execution screen 2040 of the third application based on the second position 2012 where the pinch input is identified.

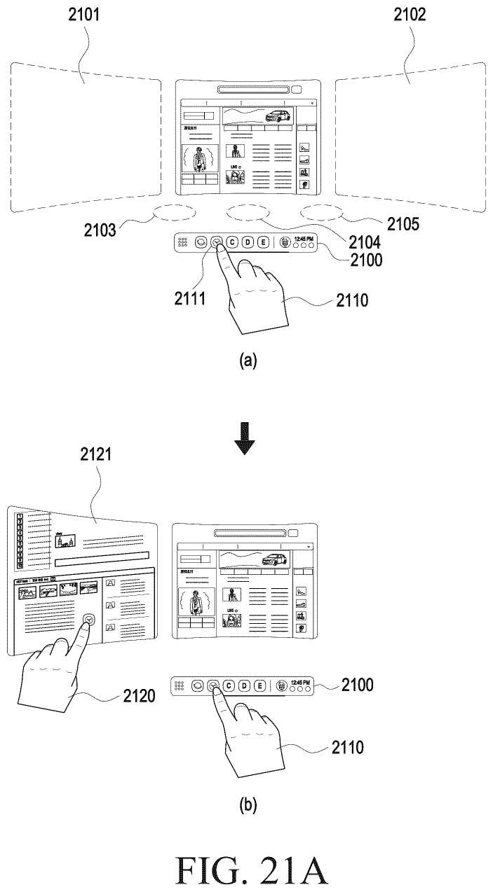

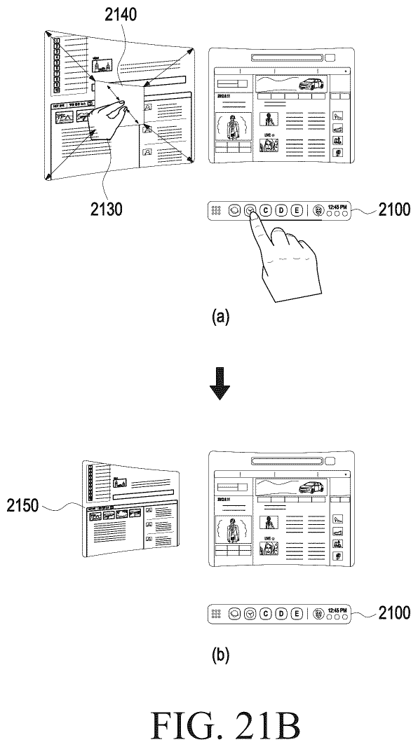

FIG. 21A is a diagram illustrating an example operation of an electronic device displaying at least one area where an execution screen of an application may be displayed according to one or more embodiments.

Referring to (a) of FIG. 21A, according to an embodiment, the electronic device 301 (e.g., the electronic device 301 of FIG. 3) may be implemented as a video see through (VST) device.

According to an embodiment, the electronic device 301 may display a user interface 2100 including at least one object representing at least one application on a first area of the display areas of the display 360 (e.g., the display 360 of FIG. 3). According to an embodiment, the at least one object may include an icon capable of executing the at least one application. According to an embodiment, the electronic device 301 may identify a first user input 2110 on a first object 2111 representing a first application included in the user interface 2100. For example, the first user input 2110 may include a long press gesture.

According to an embodiment, when the first user input 2010 is identified, the electronic device 301 may display a guide 2101, 2102, 2103, 2104, 2105 representing an area where the first execution screen of the first application may be displayed among the display areas of the display 360.

Referring to (b) of FIG. 21A, according to an embodiment, the electronic device 301 may identify a second user input 2120 to select a position to display a first window including the first execution screen on the display areas of the display 360 while the first user input 2010 is maintained. According to an embodiment, the second user input 2120 may include a long press gesture.

According to an embodiment, the electronic device 301 may display a designated screen 2121 representing the first application on a second area where the second user input 2120 is identified based on identifying the second user input 2120.

FIG. 21B is a diagram illustrating an example operation of an electronic device determining an attribute of an execution screen of an application according to one or more embodiments.

Referring to (a) of FIG. 21B, according to an embodiment, the electronic device 301 (e.g., the electronic device 301 of FIG. 3) may identify a third user input 2130 that is consecutive to the second user input 2120 on the second area while the second user input 2120 is not released. According to an embodiment, the third user input 2130 may include a pinch gesture, a pinch in gesture, or a pinch out gesture.

According to an embodiment, the electronic device 301 may determine the size of the first execution screen based on the third user input 2130. According to an embodiment, the electronic device 301 may display a screen 2140 representing the determined size of the first execution screen on the designated screen 2121 representing the first application.

Referring to (b) of FIG. 21B, according to an embodiment, the electronic device 301 may identify that the third user input 2130 is released. According to an embodiment, the electronic device 301 may display a first window 2150 including the first execution screen of the determined size on the second area.

According to an embodiment, the electronic device 301 may display the first window 2150 including the first execution screen of the determined size on the second area based on the first user input 2110 and the third user input 2130 being released.

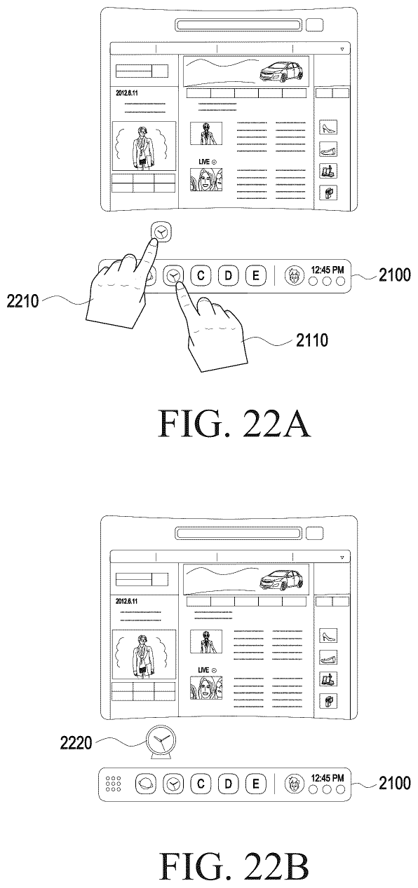

FIGS. 22A and 22B are diagrams is a illustrating an example operation of an electronic device displaying an object representing an application according to one or more embodiments.

Referring to FIG. 22A, according to an embodiment, the electronic device (e.g., the electronic device 301 of FIG. 3) may identify a first user input 2010 on a first object 2111 representing a first application included in the user interface 2100. For example, the first user input 2010 may include a long press gesture.

According to an embodiment, the electronic device 301 may identify a user input 2210 to select a position where the first object 2111 may be displayed on a third area of the display areas of the display 360 (e.g., the display 360 of FIG. 3). For example, the user input 2210 to select the position where the first object 2111 may be displayed may include a long press gesture.

Referring to FIG. 22B, according to an embodiment, the electronic device 301 may identify that the user input 2210 to select the position where the first object may be displayed is released. According to an embodiment, the electronic device 301 may display a first object 2220 with a visual effect applied on the third area based on the user input 2210 to select the position where the first object may be displayed being released. For example, the electronic device 301 may display the first object 2111 three-dimensionally.

According to an embodiment, the electronic device 301 may display the first object 2220 with the visual effect applied on the third area based on the user input 2210 to select the position where the first object may be displayed and the first user input 2110 being released.

According to an example embodiment, the electronic device 301 may include a processor 320, a display 360, and memory 330 storing instructions.

According to an example embodiment, the electronic device 301 may display a user interface including a first object representing a first application on a first area among the display areas of the display 360.

According to an example embodiment, the electronic device 301 may identify a first user input to select the first object.

According to an example embodiment, the electronic device 301 may identify a second user input to select a position to display a first window including a first execution screen of the first application on a second area of the display areas while the first user input is maintained.

According to an example embodiment, the electronic device 301 may identify at least one attribute of the first execution screen based on identifying a third user input that is consecutive to the second user input.

According to an example embodiment, the electronic device 301 may display the first window including the first execution screen corresponding to the at least one attribute on the second area based on identifying that the third user input is released.

According to an example embodiment, the electronic device 301 may display the first window including the first execution screen corresponding to the at least one attribute on the second area based on identifying that the first user input and the third user input are released.

According to an example embodiment, the electronic device 301 may display a guide representing at least one position where the first execution screen may be displayed among the display areas of the display based on identifying the first user input.

According to an example embodiment, the electronic device 301 may display a designated screen representing the first application or the first object on the second area based on identifying the second user input.

According to an example embodiment, the electronic device 301 may adjust at least one of a display position of the first window or a display position of a second window so that the first window and the second window do not overlap based on identifying a command to display the second window including a second execution screen of a second application on a third area of the display areas.

According to an example embodiment, the electronic device 301 may display the second window in the same size as the first window on the display.

According to an example embodiment, the electronic device 301 may divide and display a portion of the first execution screen and a portion of the second execution screen in one window based on identifying a command to display a second window including a second execution screen of a second application on the second area.

According to an example embodiment, the electronic device 301 may identify a fourth user input to select a second object representing a second application included in the user interface while the third user input is maintained.

According to an example embodiment, the electronic device 301 may display a second window including a second execution screen of the second application on the second area instead of the first window based on identifying that the third user input is released.

According to an example embodiment, the electronic device 301 may identify a fifth user input to swipe a second object representing a second application included in the user interface.

According to an example embodiment, the electronic device 301 may determine a display position of a second window including a second execution screen of the second application based on a speed and a direction of the fifth user input.

According to an example embodiment, the electronic device 301 may display the second window at the determined display position.

According to an example embodiment, the electronic device 301 may identify the third user input in a third area which is different from the second area while the second user input is maintained.

According to an example embodiment, the electronic device 301 may identify an attribute of the first execution screen corresponding to the third area among the at least one attribute.

According to an example embodiment, the at least one attribute of the first execution screen may include at least one of a size, a transparency, a color, or a brightness of the first execution screen.

According to an example embodiment, a method of operating the electronic device 301 may include an operation of displaying a user interface including a first object representing a first application on a first area among display areas of a display 360 included in the electronic device 301.

According to an example embodiment, the method of operating the electronic device 301 may include an operation of identifying a first user input to select the first object.

According to an example embodiment, the method of operating the electronic device 301 may include an operation of identifying a second user input to select a position to display a first window including a first execution screen of the first application on a second area of the display areas while the first user input is maintained.

According to an example embodiment, the method of operating the electronic device 301 may include an operation of determining at least one attribute of the first execution screen based on identifying a third user input that is consecutive to the second user input.

According to an example embodiment, the method of operating the electronic device 301 may include an operation of displaying the first window including the first execution screen corresponding to the at least one attribute on the second area based on identifying that the third user input is released.

According to an example embodiment, the method of operating the electronic device 301 may include an operation of displaying the first window including the first execution screen corresponding to the at least one attribute on the second area based on identifying that the first user input and the third user input are released.

According to an example embodiment, the method of operating the electronic device 301 may include an operation of displaying a guide representing at least one position where the first execution screen may be displayed among the display areas of the display based on identifying the first user input.

According to an example embodiment, the method of operating the electronic device 301 may include an operation of displaying a designated screen representing the first application or the first object on the second area based on identifying the second user input.

According to an example embodiment, the method of operating the electronic device 301 may include an operation of adjusting at least one of a display position of the first window or a display position of a second window so that the first window and the second window do not overlap based on identifying a command to display the second window including a second execution screen of a second application on a third area of the display areas.

According to an example embodiment, the method of operating the electronic device 301 may include an operation of displaying the second window in the same size as the first window.

According to an example embodiment, the method of operating the electronic device 301 may include an operation of dividing and displaying a portion of the first execution screen and a portion of the second execution screen in one window based on identifying a command to display a second window including a second execution screen of a second application on the second area.

According to an example embodiment, the method of operating the electronic device 301 may include an operation of identifying a fourth user input to select a second object representing a second application included in the user interface while the third user input is maintained.

According to an example embodiment, the method of operating the electronic device 301 may include an operation of displaying a second window including a second execution screen of the second application on the second area instead of the first window based on identifying that the third user input is released.

According to an example embodiment, the method of operating the electronic device 301 may include an operation of identifying a fifth user input to swipe a second object representing a second application included in the user interface.

According to an example embodiment, the method of operating the electronic device 301 may include an operation of determining a display position of a second window including a second execution screen of the second application based on a speed and a direction of the fifth user input.

According to an example embodiment, the method of operating the electronic device 301 may include an operation of displaying the second window at the determined display position.

According to an example embodiment, the method of operating the electronic device 301 may include an operation of identifying the third user input in a third area which is different from the second area while the second user input is maintained.

According to an example embodiment, the method of operating the electronic device 301 may include an operation of determining an attribute of the first execution screen corresponding to the third area among the at least one attribute.

According to an example embodiment, a non-transitory recording medium may store at least one instruction capable of executing an operation of displaying a user interface including a first object representing a first application on a first area among display areas of a display 360 included in an electronic device 301.

According to an example embodiment, a non-transitory computer-readable recording medium may store at least one instruction capable of executing an operation of identifying a first user input to select the first object.

According to an example embodiment, a non-transitory recording medium may store at least one instruction capable of executing an operation of identifying a second user input to select a position to display a first window including a first execution screen of the first application on a second area of the display areas while the first user input is maintained.

According to an example embodiment, a non-transitory recording medium may store at least one instruction capable of executing an operation of determining at least one attribute of the first execution screen based on identifying a third user input that is consecutive to the second user input.

According to an example embodiment, a non-transitory recording medium may store at least one instruction capable of executing an operation of displaying the first window including the first execution screen corresponding to the at least one attribute on the second area based on identifying that the third user input is released.

According to an example embodiment, a non-transitory recording medium may store at least one instruction capable of executing an operation of displaying the first window including the first execution screen corresponding to the at least one attribute on the second area based on identifying that the first user input and the third user input are released.

According to an example embodiment, a non-transitory recording medium may store at least one instruction capable of executing an operation of displaying a guide representing at least one position where the first execution screen may be displayed among the display areas of the display based on identifying the first user input.

According to an example embodiment, a non-transitory recording medium may store at least one instruction capable of executing an operation of displaying a designated screen representing the first application or the first object on the second area based on identifying the second user input.

According to an example embodiment, a non-transitory recording medium may store at least one instruction capable of executing an operation of adjusting at least one of a display position of the first window or a display position of a second window so that the first window and the second window do not overlap based on identifying a command to display the second window including a second execution screen of a second application on a third area of the display areas.

According to an example embodiment, a non-transitory recording medium may store at least one instruction capable of executing an operation of displaying the second window in the same size as the first window.

According to an example embodiment, a non-transitory recording medium may store at least one instruction capable of executing an operation of dividing and displaying a portion of the first execution screen and a portion of the second execution screen in one window based on identifying a command to display a second window including a second execution screen of a second application on the second area.

According to an example embodiment, a non-transitory recording medium may store at least one instruction capable of executing an operation of identifying a fourth user input to select a second object representing a second application included in the user interface while the third user input is maintained.

According to an example embodiment, a non-transitory recording medium may store at least one instruction capable of executing an operation of displaying a second window including a second execution screen of the second application on the second area instead of the first window based on identifying that the third user input is released.

According to an example embodiment, a non-transitory recording medium may store at least one instruction capable of executing an operation of identifying a fifth user input to swipe a second object representing a second application included in the user interface.

According to an example embodiment, a non-transitory recording medium may store at least one instruction capable of executing an operation of determining a display position of a second window including a second execution screen of the second application based on a speed and a direction of the fifth user input.

According to an example embodiment, a non-transitory recording medium may store at least one instruction capable of executing an operation of displaying the second window at the determined display position.

According to an example embodiment, a non-transitory recording medium may store at least one instruction capable of executing an operation of identifying the third user input in a third area which is different from the second area while the second user input is maintained.

According to an example embodiment, a non-transitory recording medium may store at least one instruction capable of executing an operation of determining an attribute of the first execution screen corresponding to the third area among the at least one attribute.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic device is not limited to the above-listed embodiments.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101 or 301). For example, a processor (e.g., the processor 120 or 320) of the machine (e.g., the electronic device 101 or 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
at least one processor comprising processing circuitry;
a display; and
memory storing instructions,
wherein the instructions are configured to, when executed by the at least one processor individually and/or collectively, cause the electronic device to:
control the display to display a user interface including a first object representing a first application on a first area among display areas of the display,
identify a first user input selecting the first object,
identify a second user input selecting a position to display a first window including a first execution screen of the first application on a second area of the display areas while the first user input is maintained,
based on identifying a third user input consecutive to the second user input, identify at least one attribute of the first execution screen, and
based on identifying that the third user input is released, display the first window including the first execution screen corresponding to the at least one attribute on the second area.

2. The electronic device of claim 1, wherein the instructions are configured to, when executed by the at least one processor individually and/or collectively, cause the electronic device to:
based on identifying the first user input, display, on the display, a guide representing at least one position where the first execution screen may be displayed among the display areas of the display.

3. The electronic device of claim 1, wherein the instructions are configured to, when executed by the at least one processor individually and/or collectively, cause the electronic device to:
based on identifying the second user input, display a designated screen representing the first application or the first object on the second area.

4. The electronic device of claim 1, wherein the instructions are configured to, when executed by the at least one processor individually and/or collectively, cause the electronic device to:
based on identifying a command to display a second window including a second execution screen of a second application on a third area of the display areas, adjust at least one of a display position of the first window and/or a display position of the second window so that the first window and the second window do not overlap.

5. The electronic device of claim 4, wherein the instructions are configured to, when executed by the at least one processor individually and/or collectively, cause the electronic device to:
display, on the display, the second window in a same size as the first window.

6. The electronic device of claim 1, wherein the instructions are configured to, when executed by the at least one processor individually and/or collectively, cause the electronic device to:
based on identifying a command to display a second window including a second execution screen of a second application on the second area, display, on the display, a part of the first execution screen and a part of the second execution screen in one window.

7. The electronic device of claim 1, wherein the instructions are configured to, when executed by the at least one processor individually and/or collectively, cause the electronic device to:
identify a fourth user input selecting a second object representing a second application included in the user interface while the third user input is maintained, and
based on identifying that the third user input is released, display a second window including a second execution screen of the second application on the second area instead of the first window.

8. The electronic device of claim 1, wherein the instructions are configured to, when executed by the at least one processor individually and/or collectively, cause the electronic device to:
identify a fifth user input to swipe a second object representing a second application included in the user interface,
based on a speed and a direction of the fifth user input, identify a display position of a second window including a second execution screen of the second application, and
display the second window at the identified display position.

9. The electronic device of claim 1, wherein the instructions are configured to, when executed by the at least one processor individually and/or collectively, cause the electronic device to:
identify the third user input in a third area different from the second area while the second user input is maintained, and
identify an attribute of the first execution screen corresponding to the third area among the at least one attribute.

10. The electronic device of claim 1, wherein the at least one attribute of the first execution screen includes at least one of a size, a transparency, a color, and/or a brightness of the first execution screen.

11. A method of operating an electronic device, the method comprising:
controlling a display to display a user interface including a first object representing a first application on a first area among display areas of a display (360) included in the electronic device;
identifying a first user input selecting the first object;
identifying a second user input selecting a position to display a first window including a first execution screen of the first application on a second area of the display areas while the first user input is maintained;
based on identifying a third user input consecutive to the second user input, identifying at least one attribute of the first execution screen; and
based on identifying that the third user input is released, displaying the first window including the first execution screen corresponding to the at least one attribute on the second area.

12. The method of claim 11, further comprising:
based on identifying the first user input, displaying, on the display, a guide representing at least one position where the first execution screen may be displayed among the display areas of the display.

13. The method of claim 11, further comprising:
based on identifying the second user input, displaying a designated screen representing the first application or the first object on the second area.

14. The method of claim 11, further comprising:
based on identifying a command to display a second window including a second execution screen of a second application on a third area of the display areas, adjusting at least one of a display position of the first window or a display position of the second window so that the first window and the second window do not overlap.

15. The method of claim 14, further comprising:
displaying the second window in a same size as the first window.

16. The method of claim 11, further comprising:
based on identifying a command to display a second window including a second execution screen of a second application on the second area, displaying a part of the first execution screen and a part of the second execution screen in one window.

17. The method of claim 11, further comprising:
identifying a fourth user input selecting a second object representing a second application included in the user interface while the third user input is maintained, and
based on identifying that the third user input is released, displaying a second window including a second execution screen of the second application on the second area instead of the first window.

18. The method of claim 11, further comprising:
identifying a fifth user input to swipe a second object representing a second application included in the user interface,
based on a speed and a direction of the fifth user input, identifying a display position of a second window including a second execution screen of the second application, and
displaying the second window at the identified display position.

19. The method of claim 11, further comprising:
identifying the third user input in a third area different from the second area while the second user input is maintained, and
identifying an attribute of the first execution screen corresponding to the third area among the at least one attribute.

20. A non-transitory computer-readable storage medium storing computer-readable instructions, wherein the instructions, when executed by at least one processor, comprising processing circuitry, individually and/or collectively, of an electronic device, cause the electronic device to perform at least one operation, comprising:
controlling a display to display a user interface including a first object representing a first application on a first area among display areas of a display included in the electronic device;
identifying a first user input selecting the first object;
identifying a second user input selecting a position to display a first window including a first execution screen of the first application on a second area of the display areas while the first user input is maintained;
based on identifying a third user input consecutive to the second user input, identifying at least one attribute of the first execution screen; and
based on identifying that the third user input is released, displaying the first window including the first execution screen corresponding to the at least one attribute on the second area.
